(19) United States
(12) Patent Application Publication
(10) Pub. No.: US 2023/0354234 A1
(43) Pub. Date: Nov. 2, 2023

(54) TIMING CONTROL OF REPEATERS

(71) Applicant: QUALCOMM Incorporated, San Diego, CA (US)

(72) Inventors: Navid ABEDINI, Basking Ridge, NJ (US); Tao LUO, San Diego, CA (US); Junyi LI, Fairless Hills, PA (US)

(21) Appl. No.: 18/308,499

(22) Filed: Apr. 27, 2023

Related U.S. Application Data
(60) Provisional application No. 63/363,941, filed on Apr. 29, 2022.

(51) Int. Cl. H04W 56/00

(52) U.S. Cl. CPC H04W 56/0045; H04W 56/0015

(57) ABSTRACT

In an aspect, a first network entity may perform a forwarding timing advance procedure. To perform the forwarding timing advance procedure, the first network entity may determine a first time for receiving a transmission from a second network entity based on forwarding timing advance information, where the forwarding timing advance information is based on an internal delay of the first network entity, and where a target of the transmission is a third network entity. The first network entity may receive the transmission from the second network entity at the first time. The first network entity may forward the transmission to the third network entity at a second time.

### CROSS REFERENCE TO RELATED APPLICATION(S)

This application claims the benefit of and priority to U.S. Provisional Application Ser. No. 63/363,941, entitled “Timing Control of Repeaters” and filed on Apr. 29, 2022, which is expressly incorporated by reference herein in its entirety.

### TECHNICAL FIELD

The present disclosure relates generally to communication systems, and more particularly, to wireless communication systems with repeaters.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity for wireless communication are provided. The apparatus may include a memory and at least one processor coupled to the memory. The at least one processor may be configured to perform a forwarding timing advance procedure. To perform the forwarding timing advance procedure, the at least one processor may be configured to determine a first time for receiving a transmission from a second network entity based on forwarding timing advance information, where the forwarding timing advance information is based on an internal delay of the first network entity, and where a target of the transmission is a third network entity, to receive the transmission from the second network entity at the first time, and to forward the transmission to the third network entity at a second time.

In an aspect of the disclosure, a method, a computer-readable medium, and an apparatus at a first network entity for wireless communication are provided. The apparatus may include a memory and at least one processor coupled to the memory. The at least one processor may be configured to provide, to a second network entity, a forwarding configuration, where the forwarding configuration is configured to enable the second network entity to determine, based on an internal delay of the second network entity, a first time for receiving a transmission from the first network entity or a third network entity and determine a second time for forwarding the transmission to the first network entity or the third network entity, and to perform one of: a provision of the transmission to the second network entity, or a reception of the transmission from the second network entity.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating example network-controlled repeater (NCR).

FIG. 4B is a diagram illustrating an example base station in communication with an NCR and a UE.

FIG. 5 is a call flow diagram illustrating example communications between a network node, an NCR, and a UE.

FIG. 6 is a diagram illustrating example timing associated with communications between a base station, an NCR, and a UE.

FIG. 7A is a diagram illustrating example timing associated with communications between an NCR and a UE.

FIG. 7B is a diagram illustrating example timing associated with communications between an NCR and a UE.

FIG. 8A is a diagram illustrating example timing associated with communications between an NCR and a UE.

FIG. 8B is a diagram illustrating example timing associated with communications between a base station, an NCR, and a UE.

FIG. 9 is a call flow diagram illustrating a method of wireless communication in accordance with various aspects of this present disclosure.

FIG. 10 is a flowchart illustrating methods of wireless communication at a first network entity in accordance with various aspects of the present disclosure.

FIG. 11 is a flowchart illustrating methods of wireless communication at a first network entity in accordance with various aspects of the present disclosure.

FIG. 12 is a flowchart illustrating methods of wireless communication at a first network entity in accordance with various aspects of the present disclosure.

FIG. 13 is a flowchart illustrating methods of wireless communication at a first network entity in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

Various aspects relate generally to communication systems. Some aspects more specifically relate to timing control of a repeater. In some examples, a repeater (e.g., a network-controlled repeater (NCR)) may perform a forwarding timing advance procedure. In accordance with the procedure, the repeater determines a first time for receiving a transmission from a network entity (e.g., a network node or a UE) based on forwarding timing advance information. The forwarding timing advance information may be based on an internal delay of the repeater. The first time may be determined before the transmission is received by the repeater. The repeater may forward the transmission to another network entity at a second time. For example, for uplink transmissions, the repeater may receive an uplink transmission from a UE at the determined first time and forward the uplink transmission to the network node at the second time. For downlink transmissions, the repeater may receive a downlink transmission from the network node at the determined first time and forward the downlink transmission to the UE at the second time.

Particular aspects of the subject matter described in this disclosure can be implemented to realize one or more of the following potential advantages. In some examples, by considering the internal delay of the repeater when receiving and/or forwarding a transmission, the transmission and reception boundaries of the repeater may be aligned. If such boundaries are not properly aligned, the repeater may attempt to forward a signal prematurely, thereby causing a portion of the signal to be lost. In another example, the repeater may continue to forward after transmission of the signal is complete. This may cause the repeater to transmit noise and interference, which may result in intersymbol interference at the target of the transmission (e.g., a network node or a UE). Accordingly, properly aligning the transmission and reception boundaries of the repeater enables the repeater to accurately determine when to start forwarding a signal and when to stop forwarding a signal, which prevents signal loss and interference.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

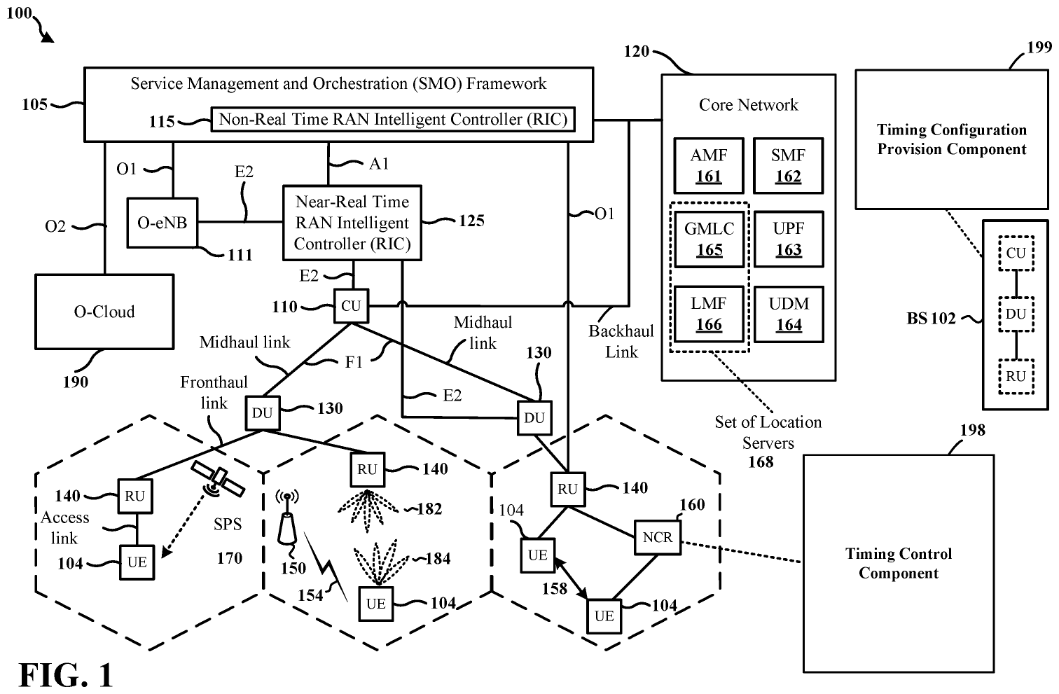

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions.

Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The wireless communications system may further include a network-controlled repeater (NCR) 160. The NCR 160 may be in-band RF repeaters used for extension of network coverage on some frequencies, such as FR1 and FR2 bands. The NCR 160 may be controlled by the base station 102 and may be an extension of the base station 102, acting on its behalf to improve coverage and service for end-users. The NCR 160 may include of a plurality of antenna arrays. A first antenna array may be oriented towards the base station 102 (e.g., the RU 140), and a second antenna array may be oriented towards to UEs (e.g., the UE 104). The NCR 160 may be configured to receive signals from the base station 102 and forward the signals to the UE 104 and may be configured to receives signals from the UE 104 and forward the signals to the base station 102.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the NCR 160 may include a timing control component 198. In some aspects, the timing control component 198 may be configured to perform a forwarding timing advance procedure. To perform the forwarding timing advance procedure, the timing control component 198 may be configured to determine a first time for receiving a transmission from a second network entity based on forwarding timing advance information, where the forwarding timing advance information is based on an internal delay of the first network entity, and where a target of the transmission is a third network entity, to receive the transmission from the second network entity at the first time, and to forward the transmission to the third network entity at a second time.

In some aspects, the base station 102 may have a timing configuration provision component 199 that may be configured to provide, to a second network entity, a forwarding configuration, where the forwarding configuration is configured to enable the second network entity to determine, based on an internal delay of the second network entity, a first time for receiving a transmission from the first network entity or a third network entity and determine a second time for forwarding the transmission to the first network entity or the third network entity, and to perform one of: a provision of the transmission to the second network entity, or a reception of the transmission from the second network entity.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

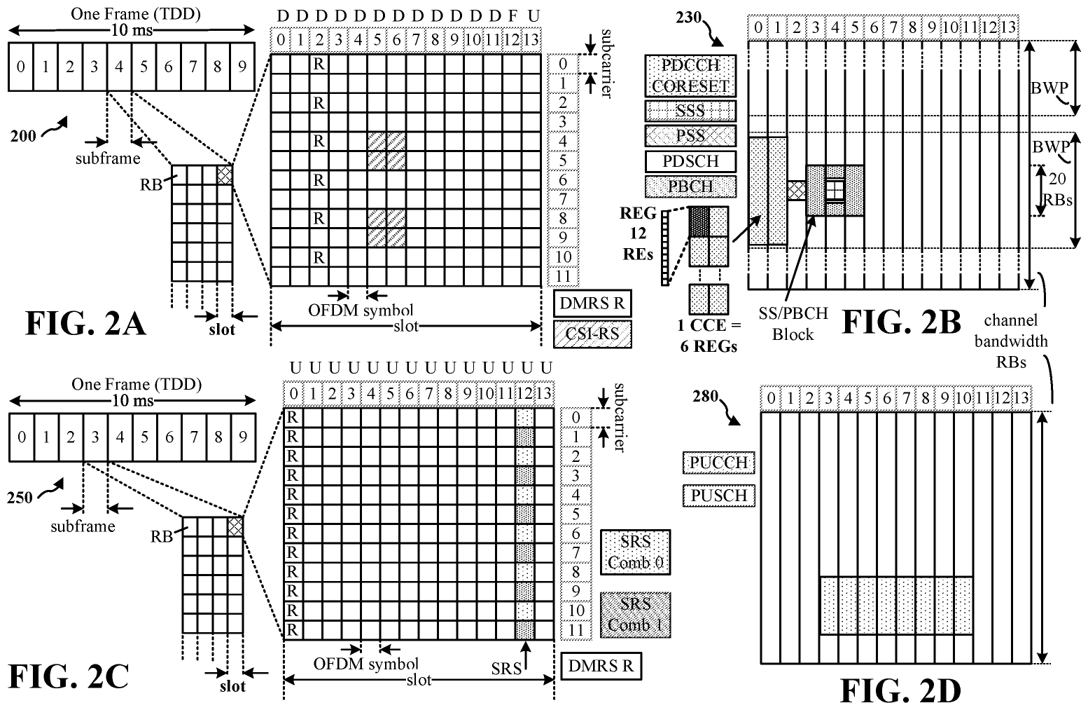

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

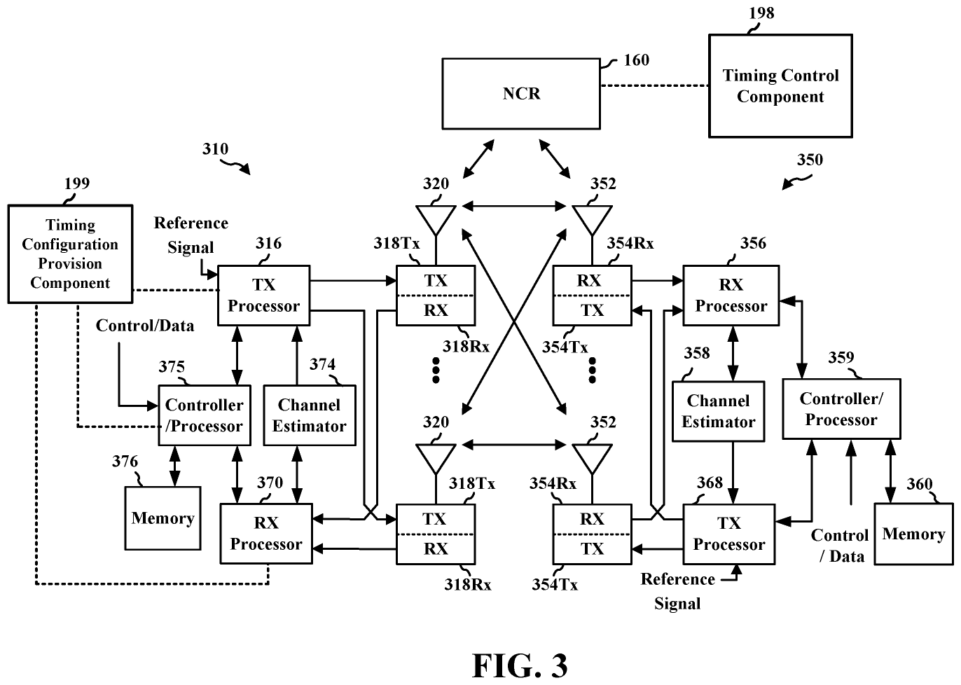

FIG. 3 is a block diagram of a base station 310 in communication with a UE 350 in an access network. In some aspects, communication between the base station 310 and the UE 350 may be provided by NCR 160, such as described in connection with any of FIGS. 1, 3, 4A, 4B, 5, 6, 7A, 7B, 8A, 8B, 9-13 and 16. The NCR 160 may include of a plurality of antenna arrays. A first antenna array may be oriented towards the base station 310, and a second antenna array may be oriented towards to the 350. The NCR 160 may be configured to receive signals from the base station 310 and forward the signals to the UE 350 and may be configured to receives signals from the UE 350 and forward the signals to the base station 310.

In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

The NCR 160 may be configured to perform aspects in connection with the timing control component 198 of FIG. 1.

At least one of the TX processor 316, the RX processor 370, and the controller/processor 375 may be configured to perform aspects in connection with the timing configuration provision component 199 of FIG. 1.

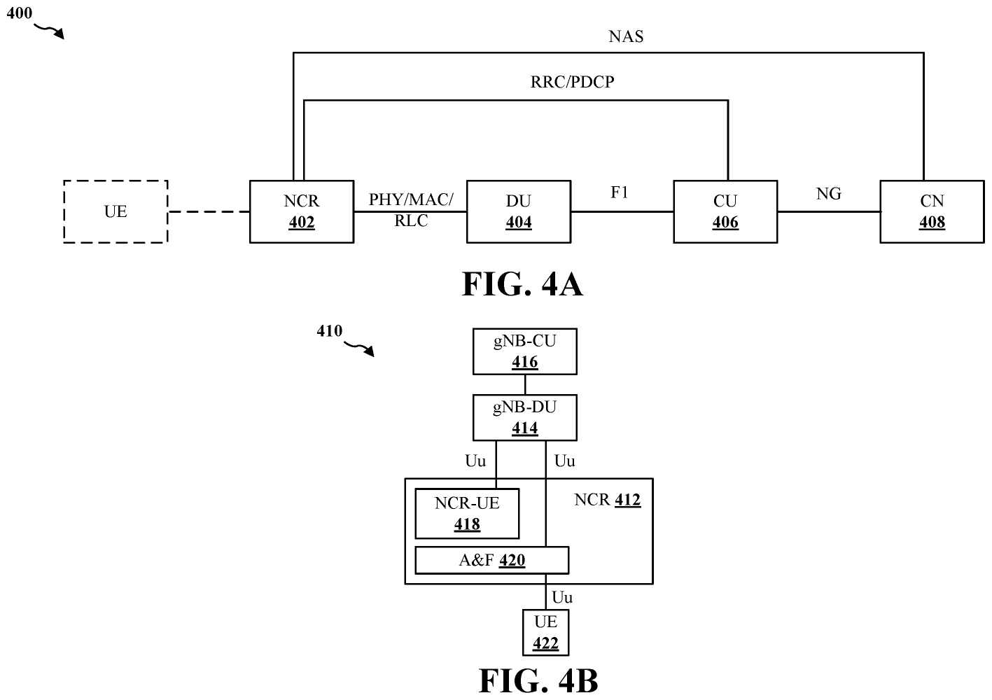

FIG. 4A is a diagram 400 illustrating an example network-controlled repeater (NCR) 402. In some aspects, NCRs may be in-band RF repeaters used for extension of network coverage on some frequencies, such as FR1 and FR2 bands. FR2-based deployments may be utilized for both outdoor and outdoor-to-indoor (O2I) scenarios. In some aspects, NCRs may be single hop stationary network-controlled repeaters (e.g., forwarding transmission from a UE to a network without additional hops of NCRs). In some aspects, NCRs may be transparent to UEs. In some aspects, NCRs may maintain the base station (e.g., gNB)-repeater link and repeater-UE link simultaneously. Some control information (e.g., side control information) may facilitate operations for network-controlled repeaters such as beamforming information, timing information to align transmission/reception boundaries of network-controlled repeaters, information on UL-DL TDD configuration, ON-OFF information for efficient interference management and improved energy efficiency, and power control information for efficient interference management. In some aspects, layer 1 (L1), layer 2 (L2), or layer 3 (L3) signalling (associated with configurations) to carry the side control information may be used. Aspects provided herein may provide timing mechanisms that may improve communications based on repeaters. As shown in FIG. 4A, the NCR 402 may be associated (and may act as) a full-stack UE. The NCR 402 may be communicatively coupled to a DU 404 via a PHY/MAC/RLC layer and may be communicatively coupled to a CU 406 via an RRC/PDCP layer. The NCR 402 may also be communicatively coupled to the core network (CN) 408 via a non-access stratum (NAS) layer.

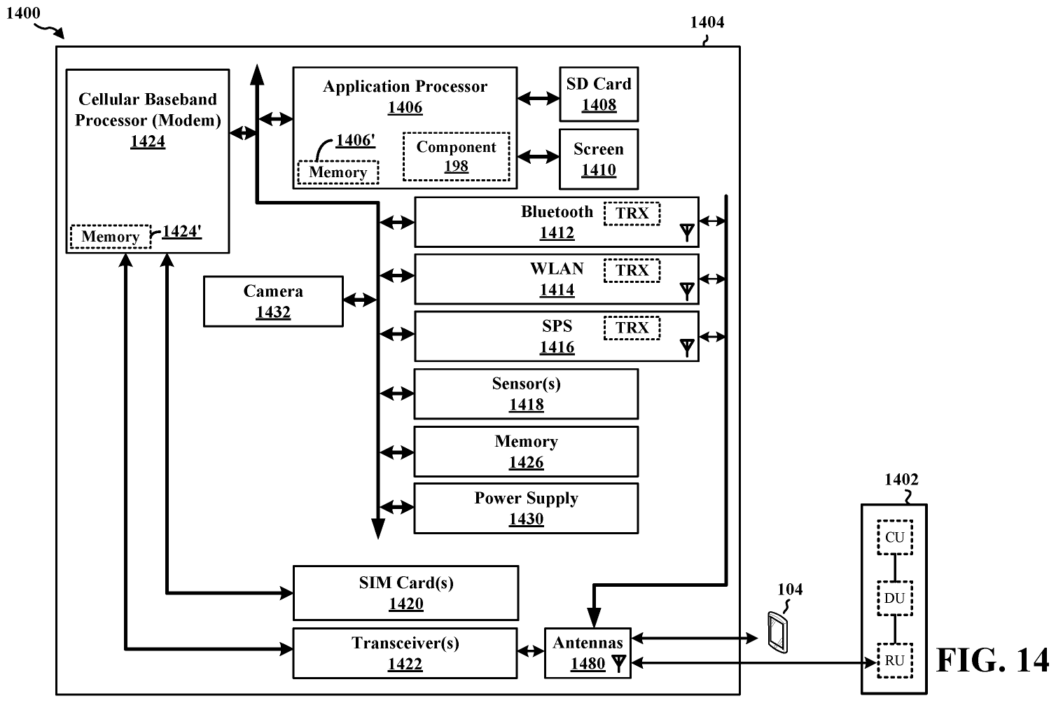

FIG. 4B is a diagram 410 illustrating an example base station in communication with an NCR 412 and a UE 422. As illustrated in FIG. 4B, the base station may include a CU 416 and a DU 414. The NCR 412 may include a UE function (shown as NCR-UE 418) and an amplify and forward (A&F) function (shown as A&F 420). The UE function may also be referred to as a mobile termination node (NCR-MT). The NCR-UE 418 may be a component of the NCR 412 that maintains the control link (C-link) between the base station and the NCR 412 to enable information exchanges (e.g., side control information). The NCR-UE 418 may include a communication interface (e.g., a modem, such as the cellular baseband processor 1424 described with reference to FIG. 14) by which the base station may control and/or configure the NCR 412, e.g., via commands or control information provided via the communication interface. The A&F 420 may also be referred to as a forwarding node (NCR-FWD). The A&F 420 may be a component of the NCR 412 that maintains a backhaul link between the base station and the NCR 412 and an access link between the NCR 412 and the UE 422. The A&F 420 may include a plurality of antennas, such as antenna elements, antenna panels, and/or antenna arrays, for transmitting and receiving RF signals. The A&F 420 may also provide gain control to amplify a signal before transmission. In some aspects, the NCR-UE 418 and the A&F 420 may be co-located. For example, the NCR-UE 418 and the A&F 420 may be included within a same device housing. In another example, the NCR-UE 418 and the A&F 420 may be located within the same room. In other aspects, the NCR-UE 418 and the A&F 420 may not be co-located. For example, NCR-UE 418 and the A&F 420 may be included in different device housings. In another example, the NCR-UE 418 may be located on a first floor of a building, and the A&F 420 may be located on a second floor of the building. The A&F 420 may receive downlink signals from the base station (e.g., from the DU 414) and forward the downlink signals to the UE 422. Similarly, the A&F 420 may receive uplink signals from the UE 422 and forward the uplink signals to the base station (e.g., to the DU 414).

As also shown in FIG. 4B, the DU 414 may be communicatively coupled to the NCR-UE 418 (such as a UE-to-UTRAN (Uu) interface). Similarly, the UE 422 may be communicatively coupled to the DU 414 via the A&F 420 utilizing a second interface (e.g., a Uu interface). For instance, signals transmitted from the UE 422 may be received by a first antenna array of the A&F 420, and the A&F 420 may be forward the signals to the DU 414 using a second antenna array of the A&F 420. Similarly, signals transmitted from the DU 414 may be received by the second antenna array of the A&F 420, and the A&F 420 may be forward the signals to the UE 422 using a second antenna array of the A&F 420.

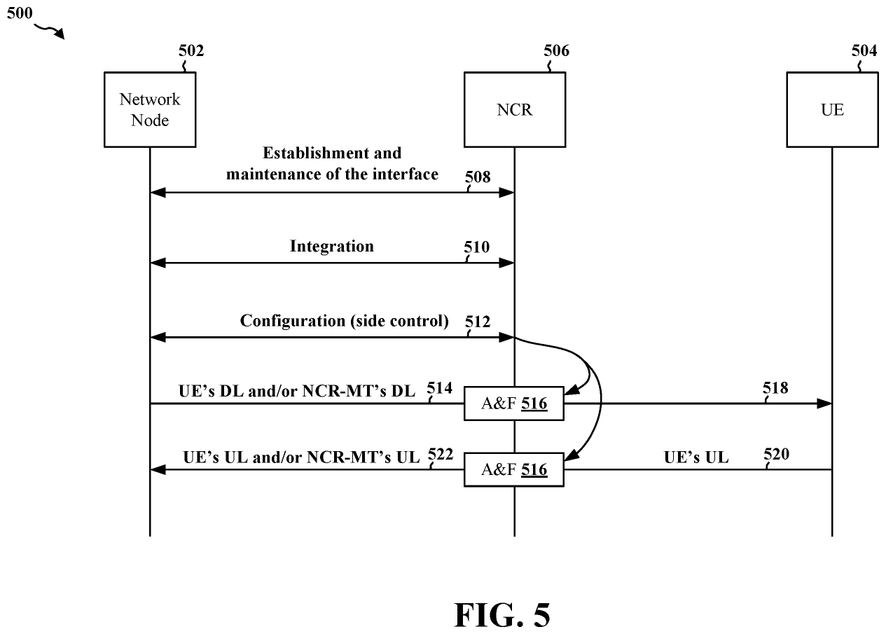

FIG. 5 is a call flow diagram 500 illustrating example communications between a network node 502, an NCR 506, and a UE 504. The network node 502 may be an example of the base station 102 or the base station 310. Although aspects are described for the network node 502, the aspects may be performed by a network node in aggregation and/or by one or more components of the network node 502 (e.g., such as a CU 110, a CU 406, or a CU 416, a DU 130, a DU 404, or a DU 414, and/or an RU 140). At 508, the NCR 506 and the network node 502 may establish and maintain an interface (e.g., a Uu interface) between each other (e.g., by which the NCR 506 and the network node 502 communicate).

At 510, during NCR integration, the NCR 506 may identify itself as a repeater (e.g., in addition to being a UE), and share its capabilities (e.g., to the network node 502 and/or other UEs (e.g., the UE 504)). The NCR 506 may perform the NCR integration based on an authorization.

At 512, during configuration, the network node 502 and/or the NCR 506 may exchange L1/L2 control messages for configuring operations for the NCR 506 (e.g., for the A&F 516 of the NCR 506).

At 514, the network node 502 may provide downlink signals for the UE 504. The NCR 506 (e.g., the A&F 516 of the NCR 506) may receive the downlink signals and, at 518, may forward the downlink signals to the UE 504. As also shown in FIG. 5, the network node 502 may also provide downlink signals to the NCR-UE (or NCR-MT) at 514. In some aspects, the downlink signals to the NCR-UE may be multiplexed with the downlink signals to the UE 504 (e.g., in the same time resources). In other aspects, the downlink signals to the NCR-UE may not be multiplexed with the downlink signals to the UE 504.

At 520, the UE 504 may provide uplink signals for the network node 502. The NCR 506 (e.g., the A&F 516 of the NCR 506) may receive the uplink signals and, at 522, may forward the uplink signals to the network node 502. As also shown in FIG. 5, the NCR 506 (e.g., the NCR-UE (or NCR-MT) of the NCR 506) may also provide uplink signals to the network node at 518. In some aspects, the uplink signals provided by the NCR-UE may be multiplexed with the uplink signals provided by the UE 504 (e.g., in the same time resources). In other aspects, the uplink signals provided by the NCR-UE may not be multiplexed with the uplink signals provided by the UE 504.

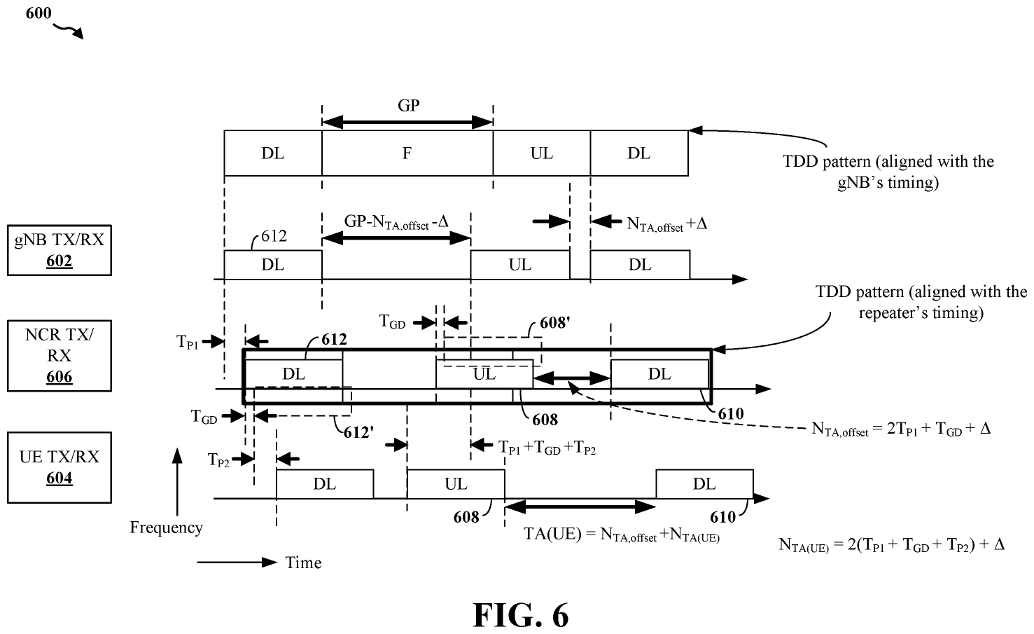

FIG. 6 is a diagram 600 illustrating example timing associated with communications between a base station 602, an NCR 606, and a UE 604. Each “DL” in FIG. 6 may be a DL slot and each “UL” in FIG. 6 may be a UL slot. The “F” in FIG. 6 may be one or more flexible slots associated with a guard period (GP) for switching from UL to DL. During a GP, a device may not transmit to avoid interference within a cell and ensure coexistence among cells by compensating for propagation delays. The parameter “T_{P1}” may represent a first propagation delay of a DL transmission, which may represent the amount of time for a DL transmission from the base station 602 to be received by the NCR 606. The parameter “T_{P2}” may represent a second propagation delay, which may represent the amount of time for a DL transmission from the NCR 606 to be received by the UE 604. The parameter “T_{GD}” may represent the group delay (also referred to as the “repeater delay” or the “internal delay”) for forwarding a UL or DL transmission by the NCR 606. The group delay may account for a propagation delay and a repeater processing delay associated with forwarding the UL/DL transmission. The group delay may correspond to the extra latency induced by the amplification chain at the repeater. That is, the group delay may correspond to the amount of time it takes the repeater to amplify and/or transmit (or forward) a received signal.

As an example, a UL frame 608 of a frame number may start in advance of the DL frame 610 of the same frame number by a timing advance (TA) that that may be equal to (N_{TA(UE)}+N_{TA,offset})T_{c}. The parameter T_{c} may represent a basic time unit, such as a one-bit period (e.g., approximately 3.69 microseconds). The parameter N_{TA,offset} may represent a TA value offset (e.g., in nanoseconds) based on a frequency band. The parameter N_{TA(UE)} may represent a TA command that is provided to the UE 604 by the base station 602. The parameter N_{TA(UE)} may be defined and/or signaled based on a location of the UE 604 and the base station 602. The parameter N_{TA(uE)} may provide the UE 604 with absolute timing or the ability to adjust the UL timing of the UE 604. By way of example, in some wireless communication systems, the TA may be a value between 0 and 63, with each step between 0 and 63 representing an advance of a one-bit period (e.g., approximately 3.69 microseconds). In some aspects, with signals (radio waves) travelling at about 300,000,000 meters per second (i.e., 300 meters per microsecond), one TA step may represent a change in round-trip distance (twice the propagation range) of approximately 1,100 meters. Therefore, in such an example, the TA may change for each 550-meter change in the range between the UE and the TRP/base station. The NCR 606 may forward the UL frame 608 in accordance with the group delay TGD of the NCR 606. The forwarded UL frame is shown as 608′.

Aspects provided herein provide mechanisms for a repeater to align its Tx/Rx timing. For a repeater with UE functionality, the repeater may follow the DL Rx timing from the base station and set its DL Rx (and DL Tx/forward) timing accordingly. For example, as illustrated in FIG. 6, the DL Tx timing is equal to the DL Rx timing (T_{P1})+T_{GD}. For instance, as shown in FIG. 6, the DL frame 612 received by the NCR 606 (based on the DL Rx timing (T_{P1})) is transmitted to the UE 604 based on the DL Tx timing. The DL frame transmitted by the NCR 606 is shown as 612′. However, for UL Rx timing, assuming no repeater delay (T_{GD}=0), the NCR 606 may receive a timing advance command TAC (2T_{P1}+Δ) for its own UL transmission (where Δ represents a value specified by the base station 602 to control the timing between downlink and uplink transmissions), which may be used for UL forwarding of the signals of the UE 604. Aspects provided herein may allow a repeater with a repeater delay to use forward timing that may facilitate improved forwarding operations. It is noted that the group delay may be non-negligible. For example, the group delay may, minimally, be a few 10 s of nanoseconds. In some deployments, the gNB-side and service-side units may be non-co-located (e.g., 100 feet of wire corresponds to 100 nanoseconds).

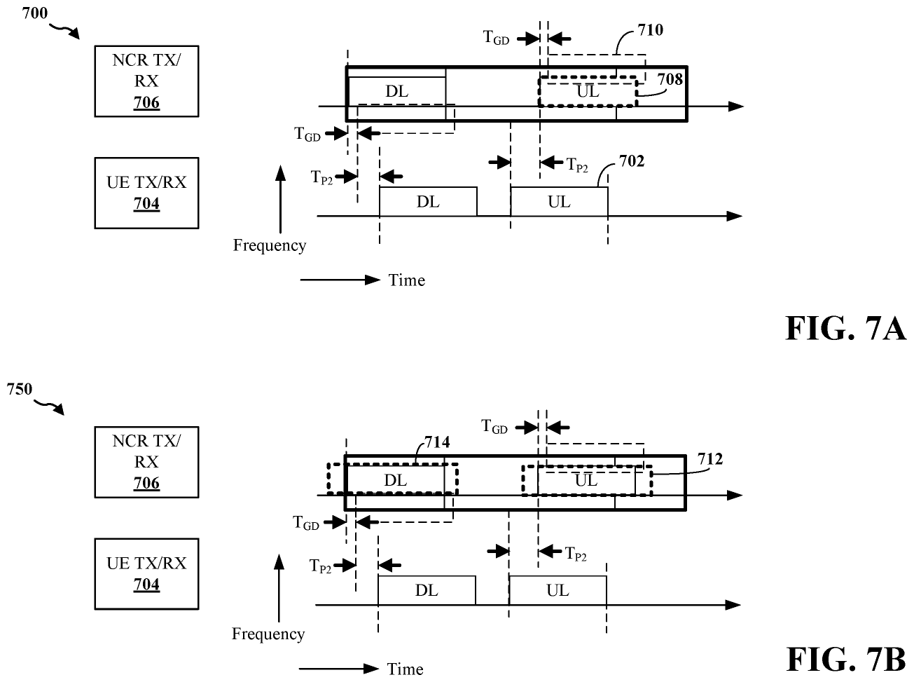

In some aspects, a repeater may know its group delay (e.g., an exact group delay or an estimate thereof) and may adjust/advance its UL forwarding timing compared to its own UL Tx timing (e.g., UL Tx timing for UL transmissions that originate from the repeater). FIG. 7A is a diagram 700 illustrating example timing associated with communications between an NCR 706 and a UE 704. As illustrated in FIG. 7A, the UE 704 may transmit a UL transmission 702 to be forwarded to a base station by the NCR 706. The NCR 706 may receive the UL transmission 702 (shown as 708) based on the propagation delay T_{P2}. The NCR 706 may forward the received UL transmission 708 based on a timing advance that is earlier than the repeater's own UL transmission 710 by a repeater delay T_{GD}. That is, the UL receive timing of the NCR 706 (e.g., the A&R (or the NCR-FWD) of the NCR 706) for the UL signal (or UL transmission 708) received by the NCR 706 from the UE 704 may be advanced before the UL transmit timing of the NCR 706 (e.g., the NCR-UE (or the NCR-MT) or the A&R (or the NCR-FWD) of the NCR 706) for the UL signal (or UL transmission 710) forwarded to the network node (e.g., the gNB). The UL receive timing may be advanced before the UL transmit timing by the internal delay T_{GD}. For instance, in some aspects, the UL receive timing of the NCR-FWD) may be advanced before the UL transmit timing of the NCR-MT (or the NCR-FWD) by a certain delay (e.g., an internal delay).

In some aspects, the group delay may not be precisely known (e.g., it may be known with an uncertainty/inaccuracy), and it may be beneficial for the NCR 706 to start receiving/forwarding UL signals with a sufficient time advance. For example, FIG. 7B is a diagram 750 illustrating example timing associated with communications between the NCR 706 and the UE 704 in which the group delay is not precisely known. As illustrated in FIG. 7B, the duration for UL forwarding (shown as 712) (or the UL forwarding window) may be increased to be greater than a single OFDM symbol to ensure that the whole UL signal may be captured at reception and forwarded. This is in contrast to the duration for UL forwarding shown in FIG. 7A (represented via a dashed box), which corresponds to the length of the UL transmission 708, as the internal delay TGA is accurately known to the NCR 706. Similarly, the duration for DL forwarding (shown as 714) (or the DL forwarding window) may be increased to be greater than a single OFDM symbol to ensure that the whole DL signal may be captured at reception and forwarded.

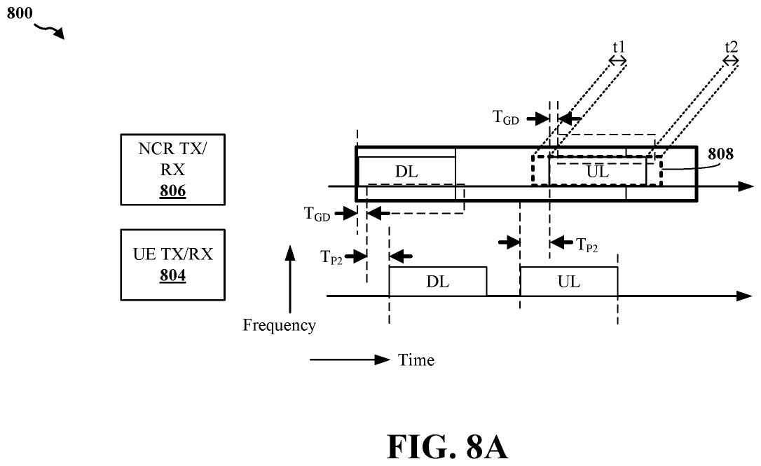

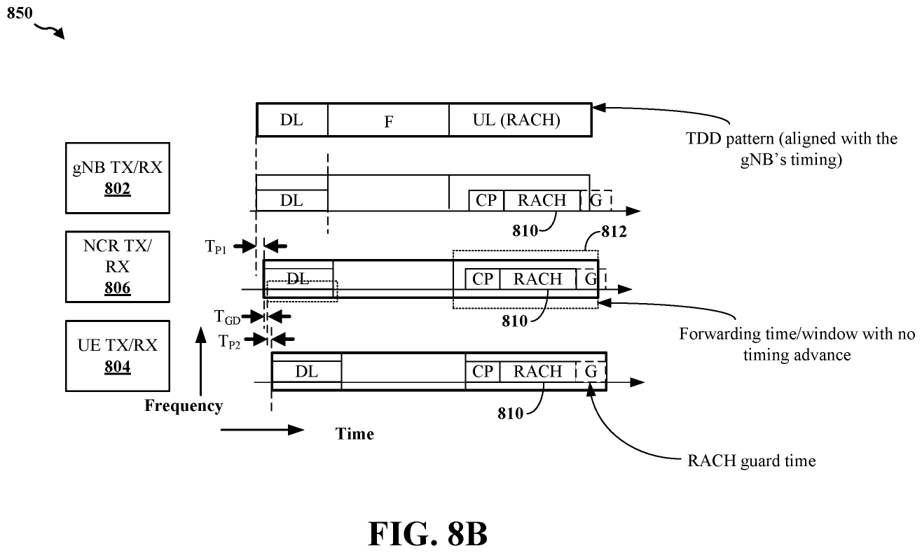

In some aspects, a repeater may be configured/indicated by the network (e.g., via L1/L2/L3 signaling) to widen its UL/DL forwarding window (e.g., the duration for UL forwarding 712, as shown in FIG. 7B). The forwarding window may be a time window configured for both monitoring the transmission to be forwarded and forwarding the transmission. FIG. 8A is a diagram 800 illustrating example timing associated with communications between an NCR 806 and a UE 804. As illustrated in FIG. 8A, the forwarding window 808 may be widened such that the NCR 806, and with respect to its own DL/UL Rx/Tx timing reference, may start at t1 (which may be a value in nanoseconds (ns)) before the first DL/UL symbol and may continue forwarding at t2 (which may be a value in ns) after the last scheduled DL/UL symbol (for the NCR 806 DL/UL transmission between the NCR 806 and the base station) in a burst. In some aspects, exact values of t1 and t2 may be indicated. In some aspects, t2 may be 0. In some aspects, t1 may be equal to t2. In some aspects, a maximum/minimum value (or a range) for either of the offset values (e.g., t1 or t2) may be indicated. In some aspects, the network (e.g., the base station) may update the offset and indicate the new offset to the NCR 806. In some aspects, the indication may be based on a relative adjustment to the current offset. In some aspects, the offset(s) may be beam-specific (each associated with a respective beam of the NCR 806, where signals transmitted or received via a first beam of the NCR 806 utilize a first set of offset values, and signals transmitted or received via a second beam of the NCR 806 utilize a second set of offset values), may be channel-specific (e.g., depending on a channel type being a PUCCH, PUSCH, PDCCH, PDSCH, PRACH, a sounding reference signal (SRS), a synchronization signal block (SSB), a channel status information (CSI) reference signal (CSI-RS), a positioning reference signal (PRS), or the like), may be specific to a set of time/frequency resources utilized for transmission or reception, or the like. In some aspects, the offset values (e.g., t1 or t2) may be different for DL and UL. In such aspects, the network may indicate to the NCR 806 which offset value is for DL and which offset is for UL.

In some aspects, the repeater may indicate to the network (e.g., via L1/L2/L3 signaling) information about the repeater delay (i.e., the group delay or the internal delay). For example, the repeater may indicate whether it knows the group delay accurately within some maximum error and/or indicate the known group delay. If it does not accurately know the group delay, the repeater may indicate uncertainty range(s) of the group delay (e.g., a range within which the group delay is expected to lie within a specified level of confidence). Two or multiple ranges may be defined, and the repeater may indicate an index (or an associated type/class). For instance, a first range may be associated with a first index (e.g., corresponding to a first type, class, or confidence level), and a second range may be associated with a second index (e.g., corresponding to a second type, class, or confidence level). The repeater may also indicate a request to authorize certain offset values (e.g., t1/t2 as described in connection with FIG. 8A). That is, the repeater may request to utilize certain offset values. The network may provide a response indicating whether the repeater is authorized to utilize the requested offset values. In some aspects, the repeater may indicate that the group delay in DL and UL directions may be different and indicate multiple values associated with different directions (e.g., the repeater may indicate a first group delay for DL transmissions and indicate a second group delay for UL transmissions). In some aspects, the repeater may indicate that the group delay within “flexible” symbols may be different (compared to DL/UL symbols whose info may be known beforehand) and/or indicate the group delay for “flexible” symbols. For example, within “flexible” symbols, the group delay may be different because the NCR 806 may not know in advance whether the “flexible” symbol will be used for UL or DL transmission. Thus, the operation of the NCR 806 with respect to “flexible” symbols may be different than UL and DL symbols. This may result in a different group delay for “flexible” symbols, as additional processing may be utilized at the NCR 806 when determining whether a “flexible” symbol is to be utilized for either UL or DL transmission. In some aspects, the repeater may indicate that the group delay in different directions (or different pairs of backhaul and access directions) may be different. For instance, the repeater may indicate that the group delay for an access link between the repeater and a UE is different than the group delay for a backhaul link between the base station and the repeater. The repeater may indicate the group delays for the access link and the backhaul link to the network. In some aspects, the group delay may be dependent on the Rx antenna array, the Tx antenna array, and/or a combination thereof. For instance, the repeater may indicate that the group delay for a set of receive antenna arrays is different than the group delay for a set of transmit antenna arrays. In such scenarios, the repeater may indicate the respective group delays for the Rx antenna array and the Tx antenna array. In some aspects, the repeater may indicate that the group delay may depend on the level of incoming signal power. In such aspects, the repeater may indicate different group delays or group delay ranges, each corresponding to a particular level of incoming signal power. In some aspects, the group delay may change over time. In such scenarios, the repeater may indicate to the network the group delay each time it changes (or changes every N times, where N is any positive integer). The network may configure the repeater with a UL or DL forwarding window that is based on the repeater delay information provided by repeater.

In some aspects, UL symbols carrying PRACH (e.g., a PRACH preamble) may be forwarded with no (i.e., without) time advance. In some aspects, a repeater, via a system information block 1 (SIB1) that provides a PRACH configuration, may know PRACH resources (e.g., may know which resources are PRACH resources based on a preamble index included in the SIB1) and may not apply timing advance for forwarding the UL signals within the PRACH resources. For example, FIG. 8B is a diagram 850 illustrating example timing associated with communications between a base station 802, an NCR 806, and a UE 804. In some aspects, the NCR 806 may explicitly receive an indication of (via L1/L2/L3 signaling) (e.g., by the base station 802) of a set of one or multiple symbols or slots within which the NCR 806 may not apply timing advance for UL forwarding. In some aspects, the indication may be dynamic (e.g., the indication may be indicated via DCI), semi-static (e.g., the indication may be indicated via RRC signaling), periodic (e.g., the indication may be periodically indicated to the NCR 806 in accordance with a periodic time frame), or semi-persistent (e.g., the indication may be indicated via a PDCCH). In some aspects, the NCR 806 may receive two or more timing offsets to apply when forwarding UL signals. In some aspects, one of the two or more timing offsets may be zero (e.g., the offset for symbol(s) or slot(s) for which timing advance is not to be applied for UL forwarding). As shown in FIG. 8B, the NCR 806 may receive an indication from the base station 802 that the symbol 810 is to be forwarded to the base station 802 without time advance. Accordingly, the forwarding time/window 812 does not have any timing advance.

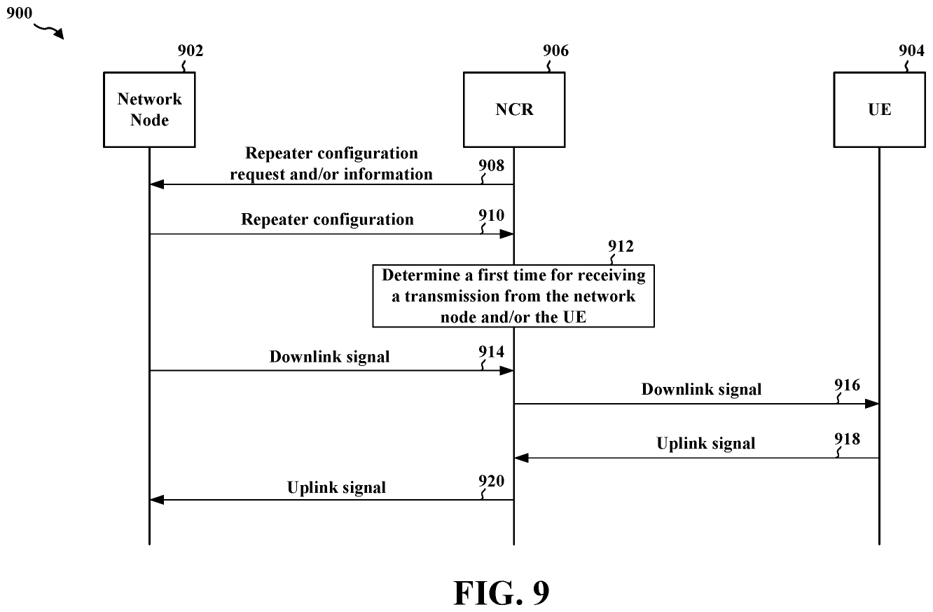

FIG. 9 is a call flow diagram 900 illustrating a method of wireless communication in accordance with various aspects of the present disclosure. As shown in FIG. 9, the diagram 900 includes a network node 902, a UE 904, and an NCR 906. The network node 902 may be an example of the base station 102, the base station 310, the network node 502, the base station 602, or the base station 802. The UE 904 may be an example of the UE 104, the UE 350, the UE 422, the UE 504, the UE 604, the UE 704, or the UE 804. The NCR 906 may be an example of the NCR 402, the NCR 412, the NCR 506, the NCR 606, the NCR 706, or the NCR 806. Although aspects are described for the network node 902, the aspects may be performed by a network node in aggregation and/or by one or more components of the network node 502 (e.g., such as a CU 110, a CU 406, or a CU 416, a DU 130, a DU 404, or a DU 414, and/or an RU 140).

At 908, the NCR 906 may provide a repeater configuration request and/or repeater information to the network node 902.

In some aspects. The NCR 906 may provide the repeater configuration request and/or the repeater information to the network node 902 via L1 signaling, L2 signaling, or L3 signaling.

In some aspects, the repeater information may include an indication representing one or more values, one or more accuracies, or one or more uncertainty ranges associated with an internal delay of the NCR 906. The internal delay may be a delay of the NCR 906 accounting for a propagation delay and a processing delay associated with forwarding transmissions to either the network node 902 or the UE 904.

In some aspects, the indication representing the uncertainty range(s) may be an index (e.g., corresponding to a first type, class, or confidence level for each of the uncertainty range(s).

In some aspects, the repeater information may include an indication that indicates that whether the internal delay is based on whether a transmission is a UL transmission or a DL transmission. The internal delay may include one or more values that may each be included in the repeater information. A first value of the value(s) of the internal delay may be associated with an UL transmission and a second value of the value(s) of the internal delay may be associated with a DL transmission. That is, the repeater information may indicate which of the internal delay value(s) are used for UL transmissions and which of the internal delay value(s) are used for DL transmissions.

In some aspects, the repeater information may include an indication that the value(s) of the internal delay are based on a direction or a set of antennas associated with a UL transmission or a DL transmission. For example, the repeater information may indicate which of the internal delay value(s) are used for a particular direction or a particular set of antennas for UL transmission and which of the internal delay value(s) are used for a particular direction or a particular set of antennas for DL transmission.

In some aspects, the repeater information may include an indication that the value(s) of the internal delay are based on a signal power associated with a reception of a UL transmission or a DL transmission. For example, the repeater information may indicate which of the internal delay value(s) are used for a particular signal power associated with a reception of a UL transmission or a DL transmission.

At 910, the network node 902 may provide a repeater configuration to the NCR 906. The repeater configuration may be based on the information provided by the NCR 906 at 908.

In some aspects, the network node 902 may provide the repeater configuration to the NCR 906 via L1 signaling, L2 signaling, or L3 signaling.

In some aspects, the repeater configuration may include forwarding timing advance information by which the NCR 906 performs a forwarding timing advance procedure. The forwarding timing advance procedure may be utilized by the NCR 906 to determine a first time for receiving a transmission from either the network node 902 or the UE 904 and/or a time for forwarding a transmission to either the network node 902 or the UE 904. The NCR 906 may utilize the forwarding timing advance information to perform the forwarding timing advance procedure. The forwarding timing advance information may include information that enables the NCR 906 to determine the first time and/or the second time. For instance, the forwarding timing advance information may include the internal delay of the NCR 906 and/or a timing advance value associated with a transmission received by the NCR 906. The timing advance value may be based on a first propagation delay between the network node 902 and the NCR 906 or a second propagation delay between the UE 904 and the NCR 906. The timing advance value may be provided to the NCR 906 by the network node 902.

In some aspects, the forwarding timing advance information may be based on a timing advance value associated with a DL transmission from the NCR 906 to the UE 904 or an UL transmission from the UE 904 to the NCR 906. The timing advance value may be received from the network node 902 at 910. For instance, the repeater configuration may include a timing advance command that indicates the timing advance value.

In some aspects, the forwarding timing advance information may be equal to a combination of the timing advance value and the internal delay of the NCR 906. In some aspects, the forwarding timing advance information may be equal to the timing advance value plus the internal delay.

In some aspects, the forwarding time advance information may include the timing advance value, and the NCR 906 may determine the forwarding timing advance information based on the timing advance value and its internal delay, which may be known to the NCR 906.

In some aspects, the repeater configuration may include a forwarding configuration by which the NCR 906 forwards transmissions to the network node 902 or the UE 904.

In some aspects, the forwarding configuration may include an indication of a UL forwarding window or a DL forwarding window associated with the forwarding timing advance procedure. The UL forwarding window or the DL forwarding window may represent a time window configured for receiving a UL or DL transmission and forwarding the UL or DL transmission.

In some aspects, the indication included in the forwarding configuration may include a first value or a first range associated with a start time of the UL forwarding window or the DL forwarding window and a second value or a second range associated with an end time of the UL forwarding window or the DL forwarding window, the start time being earlier than the second time.

In some aspects, the forwarding configuration may include an indication of an instruction to forward at least one transmission associated with a set of time and frequency resources without a timing advance, where the indication is dynamic, semi-static, periodic, or semi-persistent. In some aspects, the timing advance may correspond with one of the timing advance value or the forwarding timing advance information.

In some aspects, the forwarding configuration may include an indication of an instruction to forward at least one transmission associated with a PRACH without a timing advance, where the indication is dynamic, semi-static, periodic, or semi-persistent. In some aspects, the timing advance may correspond with one of the timing advance value or the forwarding timing advance information.

At 912, the NCR 906 may perform a forwarding timing advance procedure, for example, by determining a first time for receiving a transmission from either the network node 902 or the UE 904 based on the forwarding timing advance information. As described above, the forwarding timing advance information may be based on the internal delay of the NCR 906. The target of the transmission may be the network node 902 if the transmission is received from the UE 904. The target of the transmission may be the UE 904 if the transmission is from the network node 902.

In some aspects, for a DL transmission from the network node 902 to the UE 904, the forwarding advance timing procedure may be based on a timing advance value associated with the DL transmission. For a UL transmission from the UE 904 to the network node 902, the forwarding advance timing procedure may be based on a timing advance value associated with the UL transmission. The start time of the UL forwarding window may be earlier than a start time of the DL transmission or the UL transmission based on the timing advance value by a third value (e.g., t1, as shown in FIG. 8A). The end time of the UL forwarding window or the DL forwarding window may be later than an end of the DL transmission or the UL transmission by a fourth value (e.g., t2, as shown in FIG. 8A).

In some aspects, the third value or the fourth value may be associated with a channel type for the DL or UL transmission, a beam associated with receiving or forwarding the DL or UL transmission, or a set of time or frequency resources associated with the DL or UL transmission.

In some aspects, the channel type may be one of a PUSCH, a PUCCH, a PDSCH, a PDCCH, a PRACH, an SRS, an SSB, a CSI-RS, or a PRS.

In some aspects, the NCR 906 may transmit a request, to the network node 902, for the third value and/or the fourth value, for example, at 908. In such aspects, the network node 902 may provide the third value and/or the fourth value via the repeater configuration received at 910.

In one example, at 914, the network node 902 may provide a downlink signal to the NCR 906, and the NCR 906 may receive the downlink signal from the NCR 906 at the first time determined at 912. At 916, the NCR 906 may forward the downlink signal to the UE 904 at a second time.

As described above, the forwarding timing advance procedure for the downlink signal may be based on a combination of a timing advance value associated with the downlink signal and the internal delay of the NCR 906.

The downlink signal may be forwarded based on the forwarding configuration received at 910.

In another example, at 918, the UE 904 may provide an uplink signal to the NCR 906, and the NCR 906 may receive the uplink signal from the NCR 906 at the first time determined at 912. At 920, the NCR 906 may forward the uplink signal to the network node 902 at a second time.

As described above, the forwarding timing advance procedure for the uplink signal may be based on a combination of a timing advance value associated with the uplink signal and the internal delay of the NCR 906.

The uplink signal may be forwarded based on the forwarding configuration received at 910.

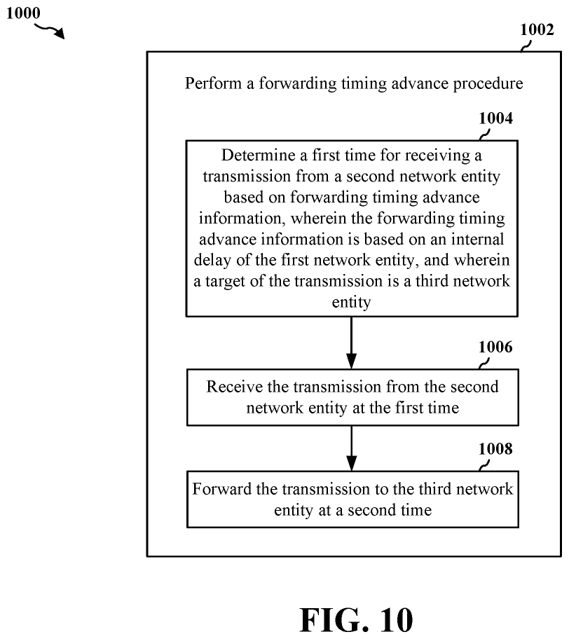

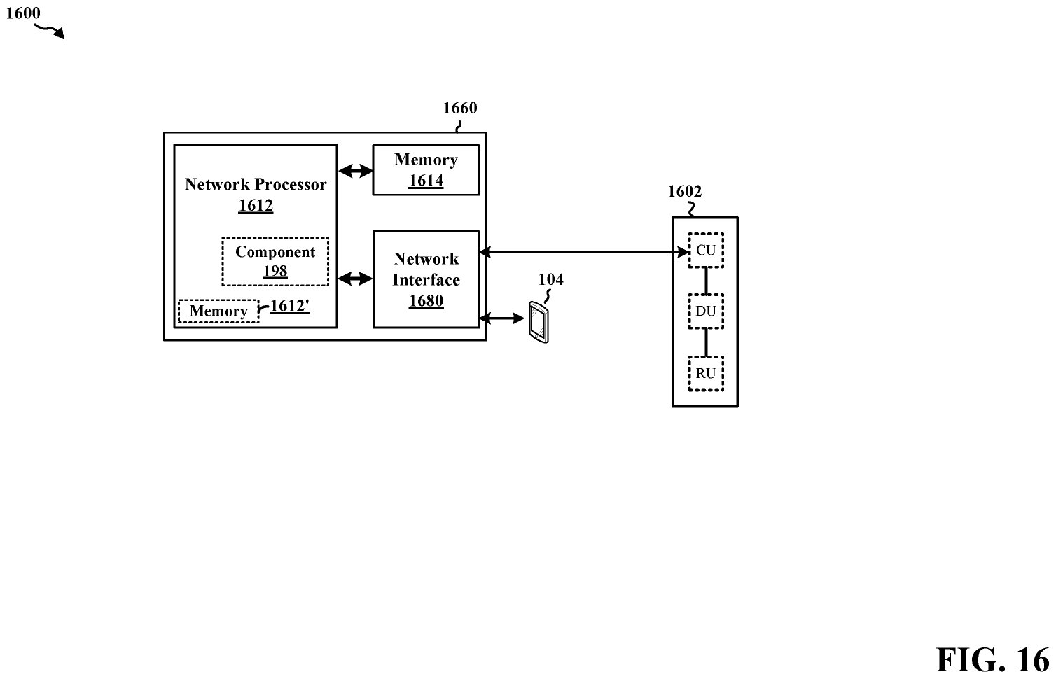

FIG. 10 is a flowchart 1000 illustrating methods of wireless communication at a first network entity in accordance with various aspects of the present disclosure. In some aspects, the first network entity may be the NCR 402, the NCR 412, the NCR 506, the NCR 606, the NCR 706, the NCR 806, or the NCR 906 (or at least one component thereof (e.g., the NCR-UE 418 or the A&F 420) or the network entity 1660 in the hardware implementation of FIG. 16.

At 1002, the first network entity may perform a forwarding timing advance procedure. To perform the forwarding timing advance procedure, in some aspects, as part of 1002, at 1004, the first network entity may determine a first time for receiving a transmission from a second network entity based on forwarding timing advance information, where the forwarding timing advance information is based on an internal delay of the first network entity, and where a target of the transmission is a third network entity. For example, referring to FIG. 9, in an aspect in which the forwarding timing advance procedure is performed for a DL transmission (i.e., a downlink forwarding timing advance procedure), the first network node is a base station (e.g., the network node 902), or at least one component thereof, and the third network node is a UE (e.g., the UE 904), or at least one component thereof, the NCR 906, at 912, may determine a first time for receiving a transmission (e.g., the downlink signal at 914) from the network node 902 based on forwarding timing advance information, where the forwarding timing advance information is based on an internal delay of the NCR 906, and where a target of the transmission is the UE 904. In an aspect in which the forwarding timing advance procedure is performed for a UL transmission (i.e., an uplink forwarding timing advance procedure), the first network node is a UE (e.g., the UE 904), or at least one component thereof, and the third network node is a base station (e.g., the network node 902), or at least one component thereof, the NCR 906, at 912, may determine a first time for receiving a transmission (e.g., the uplink signal at 918) from the UE 904 based on forwarding timing advance information, where the forwarding timing advance information is based on the internal delay of the NCR 906, and where a target of the transmission is the network node 902. In an aspect, 1004 may be performed by the timing control component 198.

In some aspects, the forwarding timing advance procedure may be based on a timing advance value associated with a DL transmission or an UL transmission from the first network entity to the third network entity. For example, referring to FIG. 9, the forwarding timing advance procedure performed by the NCR 906 may be based on a timing advance value associated with a DL transmission (e.g., the downlink signal at 914) from the network node 902 to the UE 904. In another example, referring to FIG. 9, the forwarding timing advance procedure performed by the NCR 906 may be based on a timing advance value associated with a UL transmission (e.g., the uplink signal at 918) from the UE 904 to the network node 902.

In some aspects, the forwarding timing advance information is equal to the timing advance value plus the internal delay. For example, referring to FIG. 9, the forwarding timing advance information on which the first time determination at 912 is based may be equal to the timing advance value plus the internal delay of the NCR 906.

In some aspects, the internal delay may be a delay of the first network entity accounting for a propagation delay and a processing delay associated with forwarding the transmission. For example, referring to FIG. 9, the internal delay may be a delay of the NCR 906 accounting for a propagation delay and a processing delay associated with forwarding the transmission.

As part of 1002, at 1006, the first network entity may receive the transmission from the second network entity at the first time. For example, referring to FIG. 9, in an aspect in which the forwarding timing advance procedure is performed for a DL transmission, the NCR 906, at 914, may receive a downlink signal from the network node 902 at the first time determined at 912. In an aspect in which the forwarding timing advance procedure is performed for a UL transmission, NCR 906, at 918, may receive an uplink signal from the UE 904 at the first time determined at 912. In an aspect, 1006 may be performed by the timing control component 198.

As part of 1002, at 1008, the first network entity may forward the transmission to the third network entity at a second time. For example, referring to FIG. 9, in an aspect in which the forwarding timing advance procedure is performed for a DL transmission, the NCR 906, at 916, may forward the downlink signal to the UE 904. In an aspect in which the forwarding timing advance procedure is performed for a UL transmission, the NCR 906, at 920, may forward the uplink signal to the network node 902. In an aspect, 1008 may be performed by the timing control component 198.

In some aspects, the first network entity may receive a forwarding configuration from the second network entity or the third network entity via L1, L2, or L3 signaling, and the first network entity may forward the transmission based on the forwarding configuration. For example, referring to FIG. 9, in an aspect in which a DL forwarding timing advance procedure is performed, the second network entity is the network node 902, and the third network entity is the UE 904, the NCR 906, at 910, may receive a forwarding configuration from the network node 902, and may forward the downlink signal at 916 based on the forwarding configuration. In an aspect in which a UL forwarding timing advance procedure is performed, the second network entity is the UE 904, and the third network entity is the network node 902, the NCR 906, at 910, may receive a forwarding configuration from the network node 902, and may forward the uplink signal at 920 based on the forwarding configuration.

In some aspects, the forwarding configuration may include an indication of a UL forwarding window or a DL forwarding window associated with the forwarding timing advance procedure, where the UL forwarding window or the DL forwarding window represents a time window configured for receiving the transmission and forwarding the transmission. For example, referring to FIG. 9, the forwarding configuration received at 910 may include an indication of a UL forwarding window or a DL forwarding window associated with the forwarding timing advance procedure, where the UL forwarding window or the DL forwarding window represents a time window configured for receiving the transmission (e.g., receiving the uplink signal at 918 or receiving the downlink signal at 914) and forwarding the transmission (e.g., forwarding the uplink signal at 920 or forwarding the downlink signal at 916).

In some aspects, the indication may include a first value or a first range associated with a start time of the UL forwarding window or the DL forwarding window and a second value or a second range associated with an end time of the UL forwarding window or the DL forwarding window, the start time being earlier than the second time. For example, referring to FIG. 9, the indication of the forwarding configuration received at 910 may include a first value or a first range associated with a start time of the UL forwarding window or the DL forwarding window and a second value or a second range associated with an end time of the UL forwarding window or the DL forwarding window, the start time being earlier than the second time.

In some aspects, the forwarding advance timing procedure may be based on a timing advance value associated with a DL transmission or an UL transmission from the first network entity to the third network entity, where the start time is earlier than a start time of the DL transmission or the UL transmission based on the timing advance value by a third value and the end time is later than an end of the DL transmission or the UL transmission by a fourth value. For example, referring to FIG. 9, in an aspect in which a DL forwarding advance timing procedure is performed, the second network entity is the network node 902, and the third network entity is the UE 904, the forwarding advance timing procedure performed by the NCR 906 may be based on a timing advance value associated with the downlink signal (e.g., received at 914) from the network node 902 to the UE 904, where the start time is earlier than a start time of the downlink signal based on the timing advance value by a third value and the end time is later than an end of the downlink signal by a fourth value. In an aspect in which a UL forwarding advance timing procedure is performed, the second network entity is the UE 904, and the third network entity is the network node 902, the forwarding advance timing procedure performed by the NCR 906 may be based on a timing advance value associated with the uplink signal (e.g., received at 918) from the UE 904 to the network node 902, where the start time is earlier than a start time of the uplink signal based on the timing advance value by a third value and the end time is later than an end of the uplink signal by a fourth value.

In some aspects, the third value or the fourth value may be associated with a channel type for the transmission, a beam associated with receiving or forwarding the transmission, or a set of time or frequency resources associated with the transmission. For example, referring to FIG. 9, the third value or the fourth value included in the forwarding configuration received at 910 may be associated with a channel type for the transmission (e.g., the downlink signal received at 914 or the uplink signal received at 918), a beam associated with receiving or forwarding the transmission, or a set of time or frequency resources associated with the transmission.

In some aspects, the channel type is one of a PUSCH, a PUCCH, a PDSCH, a PDCCH, a PRACH, an SRS, an SSB, a CSI-RS, or a PRS. For example, referring to FIG. 9, the channel type associated with the third value or the fourth value included in the forwarding configuration received at 910 may be one of a PUSCH, a PUCCH, a PDSCH, a PDCCH, a PRACH, an SRS, an SSB, a CSI-RS, or a PRS.

In some aspects, the first network entity may transmit a request for the third value or the fourth value to the second network entity or the third network entity via the L1, L2, or L3 signaling. For example, referring to FIG. 9, in an aspect in which the second network entity or the third network entity is the network node 902, the NCR 906, at 908, may transmit a request, to the network node 902, for the third value or the fourth value via the L1, L2, or L3 signaling.

In some aspects, the forwarding configuration may include an indication of an instruction to forward at least one transmission associated with a set of time and frequency resources without a timing advance, where the indication is dynamic, semi-static, periodic, or semi-persistent. For example, referring to FIG. 9, the forwarding configuration received at 910 may include an indication of an instruction to forward at least one transmission associated with a set of time and frequency resources without a timing advance, where the indication is dynamic, semi-static, periodic, or semi-persistent. In some aspects, the timing advance may correspond with one of the timing advance value or the forwarding timing advance information. For example, referring to FIG. 9, the timing advance may correspond with one of the timing advance value or the forwarding timing advance information on which the first time determination at 912 is based.

In some aspects, the forwarding configuration may include an indication of an instruction to forward at least one transmission associated with a PRACH without a timing advance, where the indication is dynamic, semi-static, periodic, or semi-persistent. For example, referring to FIG. 9, the forwarding configuration received at 910 may include an indication of an instruction to forward at least one transmission associated with a PRACH without a timing advance, where the indication is dynamic, semi-static, periodic, or semi-persistent. In some aspects, the timing advance may correspond with one of the timing advance value or the forwarding timing advance information. For example, referring to FIG. 9, the timing advance may correspond with one of the timing advance value or the forwarding timing advance information on which the first time determination at 912 is based.

In some aspects, the first network entity may transmit an indication representing value(s), accuracy(ies), or uncertainty range(s) associated with the internal delay to the second network entity or the third network entity via L1, L2, or L3 signaling. For example, referring to FIG. 9, in aspects in which the second network entity or the third network entity is the network node 902, the NCR 906, at 908, may transmit an indication representing value(s), accuracy(ies), or uncertainty range(s) associated with the internal delay of the NCR 906 to the network node 902 via L1, L2, or L3 signaling.

In some aspects, the indication representing the uncertainty range(s) may be an index. For example, referring to FIG. 9, the indication transmitted at 908 representing the uncertainty range(s) may be an index.

In some aspects, the indication may further indicate that the internal delay is based on whether the transmission is a UL transmission or a DL transmission, where a first value of the value(s) of the internal delay is associated with the transmission being the UL transmission and a second value of the value(s) of the internal delay is associated with the transmission being the DL transmission. For example, referring to FIG. 9, the indication transmitted at 908 may further indicate that the internal delay of the NCR 906 is based on whether the transmission is a UL transmission or a DL transmission, where a first value of the value(s) of the internal delay of the NCR 906 is associated with the transmission being the UL transmission and a second value of the value(s) of the internal delay of the NCR 906 is associated with the transmission being the DL transmission.

In some aspects, the indication may further indicate that the value(s) of the internal delay is based on a direction or a set of antennas associated with the transmission. For example, referring to FIG. 9, the indication transmitted at 908 may further indicate that the value(s) of the internal delay of the NCR 906 are based on a direction or a set of antennas (e.g., of the NCR 906) associated with the transmission.

In some aspects, the indication may further indicate that the value(s) of the internal delay is based on a signal power associated with a reception of the transmission. For example, referring to FIG. 9, the indication transmitted at 908 may further indicate that the value(s) of the internal delay of the NCR 906 are based on a signal power (e.g., determined by the NCR 906) associated with a reception of the transmission.

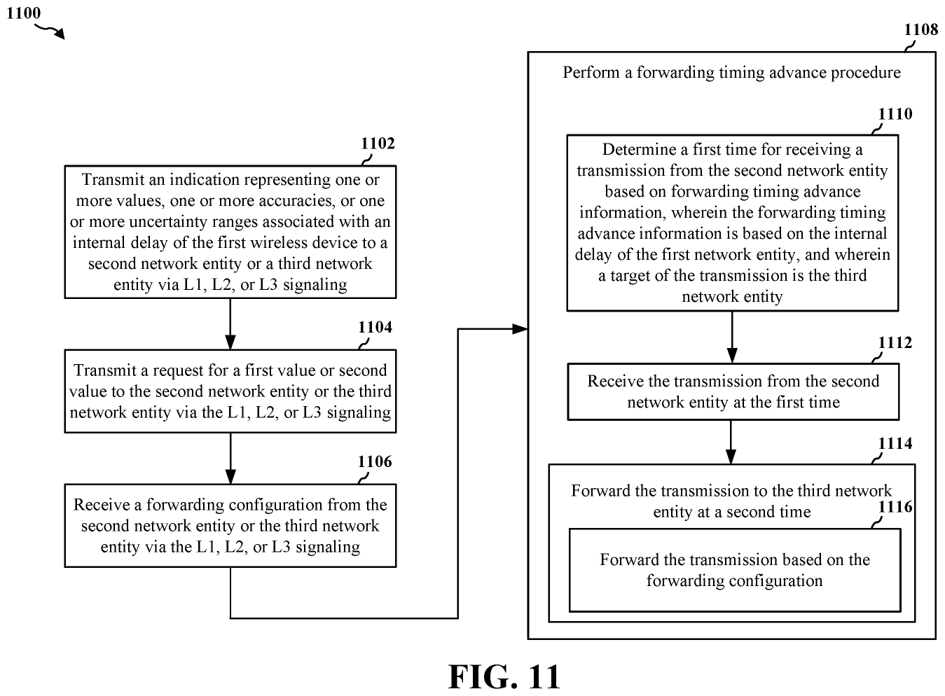

FIG. 11 is a flowchart 1100 illustrating methods of wireless communication at a first network entity in accordance with various aspects of the present disclosure. In some aspects, the first network entity may be the NCR 402, the NCR 412, the NCR 506, the NCR 606, the NCR 706, the NCR 806, or the NCR 906 (or at least one component thereof (e.g., the NCR-UE 418 or the A&F 420) or the network entity 1660 in the hardware implementation of FIG. 16.

At 1102, the first network entity may transmit an indication representing value(s), accuracy(ies), or uncertainty range(s) associated with an internal delay of the first network entity to a second network entity or a third network entity via L1, L2, or L3 signaling. For example, referring to FIG. 9, in aspects in which the second network entity or the third network entity is the network node 902, the NCR 906, at 908, may transmit an indication representing value(s), accuracy(ies), or uncertainty range(s) associated with the internal delay of the NCR 906 to the network node 902 via L1, L2, or L3 signaling. In an aspect, 1102 may be performed by the timing control component 198.

In some aspects, the first network entity may correspond to a repeater or at least one component of the repeater, the second network entity may correspond to a UE or at least one component of the UE, and the third network entity may correspond to a base station or one or more components of the base station. For example, referring to FIG. 9, the first network entity may correspond to the NCR 906 or at least one component of the NCR 906, the second network entity may correspond to the UE 904 or at least one component of the UE 904, and the third network entity may correspond to the network node 902. In such aspects, the forwarding timing advance procedure described below with reference to 1108 may be a UL forwarding timing advance procedure.

In some aspects, the first network entity may correspond to a repeater or at least one component of the repeater, the third network entity may correspond to a UE or at least one component of the UE, and the second network entity may correspond to a base station or one or more components of the base station. For example, referring to FIG. 9, the first network entity may correspond to the NCR 906 or at least one component of the NCR 906, the third network entity may correspond to the UE 904 or at least one component of the UE 904, and the second network entity may correspond to the network node 902. In such aspects, the forwarding timing advance procedure described below with reference to 1108 may be a UL forwarding timing advance procedure. In such aspects, the forwarding timing advance procedure described below with reference to 1108 may be a DL forwarding timing advance procedure.

In some aspects, the internal delay may be a delay of the first network entity accounting for a propagation delay and a processing delay associated with forwarding the transmission. For example, referring to FIG. 9, the internal delay may be a delay of the NCR 906 accounting for a propagation delay and a processing delay associated with forwarding the transmission.

In some aspects, the indication representing the uncertainty range(s) may be an index. For example, referring to FIG. 9, the indication transmitted at 908 representing the uncertainty range(s) may be an index.

In some aspects, the indication may further indicate that the internal delay is based on whether a transmission received by the repeater is a UL transmission or DL transmission, where a first value of the value(s) of the internal delay is associated with the transmission being the UL transmission and a second value of the value(s) of the internal delay is associated with the transmission being the DL transmission. For example, referring to FIG. 9, the indication transmitted at 908 may further indicate that the internal delay of the NCR 906 is based on whether the transmission received by the repeater is UL a transmission or a DL transmission, where a first value of the value(s) of the internal delay of the NCR 906 is associated with the transmission being the UL transmission and a second value of the value(s) of the internal delay of the NCR 906 is associated with the transmission being the DL transmission.

In some aspects, the indication may further indicate that the value(s) of the internal delay are based on a direction or a set of antennas associated with the transmission. For example, referring to FIG. 9, the indication transmitted at 908 may further indicate that the value(s) of the internal delay of the NCR 906 are based on a direction or a set of antennas (e.g., of the NCR 906) associated with the transmission.

In some aspects, the indication may further indicate that the value(s) of the internal delay are based on a signal power associated with a reception of the transmission. For example, referring to FIG. 9, the indication transmitted at 908 may further indicate that the value(s) of the internal delay of the NCR 906 are based on a signal power (e.g., determined by the NCR 906) associated with a reception of the transmission.

At 1104, the first network entity may transmit request for a first value or second value to the second network entity or the third network entity via the L1, L2, or L3 signaling. For example, referring to FIG. 9, in an aspect in which the second network entity or the third network entity is the network node 902, the NCR 906, at 908, may transmit a request, to the network node 902, for the first value or the second value via the L1, L2, or L3 signaling. In an aspect, 1104 may be performed by the timing control component 198.

In some aspects, the first value or the second value may be associated with a channel type for a transmission received by the first network entity, a beam associated with receiving or forwarding the transmission, or a set of time or frequency resources associated with the transmission. For example, referring to FIG. 9, the first value or the second value included in the forwarding configuration received at 910 may be associated with a channel type for the transmission (e.g., the downlink signal received at 914 or the uplink signal received at 918), a beam associated with receiving or forwarding the transmission, or a set of time or frequency resources associated with the transmission.

In some aspects, the channel type is one of a PUSCH, a PUCCH, a PDSCH, a PDCCH, a PRACH, an SRS, an SSB, a CSI-RS, or a PRS. For example, referring to FIG. 9, the channel type associated with the third value or the fourth value included in the forwarding configuration received at 910 may be one of a PUSCH, a PUCCH, a PDSCH, a PDCCH, a PRACH, an SRS, an SSB, a CSI-RS, or a PRS.

At 1106, the first network entity may receive a forwarding configuration from the second network entity or the third network entity via L1, L2, or L3 signaling. For example, referring to FIG. 9, in an aspect in which a DL forwarding timing advance procedure is performed, the second network entity is the network node 902, and the third network entity is the UE 904, the NCR 906, at 910, may receive a forwarding configuration from the network node 902. In an aspect in which a UL forwarding timing advance procedure is performed, the second network entity is the UE 904, and the third network entity is the network node 902, the NCR 906, at 910, may receive a forwarding configuration from the network node 902. In an aspect, 1106 may be performed by the timing control component 198.

At 1108, the first network entity may perform a forwarding timing advance procedure. To perform the forwarding timing advance procedure, in some aspects, as part of 1108, at 1110, the first network entity may determine a first time for receiving a transmission from the second network entity based on forwarding timing advance information, where the forwarding timing advance information is based on the internal delay of the first network entity, and where a target of the transmission is the third network entity. For example, referring to FIG. 9, in an aspect in which the forwarding timing advance procedure is performed for a DL transmission (i.e., a downlink forwarding timing advance procedure), the first network node is a base station (e.g., the network node 902), or at least one component thereof, and the third network node is a UE (e.g., the UE 904), or at least one component thereof, the NCR 906, at 912, may determine a first time for receiving a transmission (e.g., the downlink signal at 914) from the network node 902 based on forwarding timing advance information, where the forwarding timing advance information is based on an internal delay of the NCR 906, and where a target of the transmission is the UE 904. In an aspect in which the forwarding timing advance procedure is performed for a UL transmission (i.e., an uplink forwarding timing advance procedure), the first network node is a UE (e.g., the UE 904), or at least one component thereof, and the third network node is a base station (e.g., the network node 902), or at least one component thereof, the NCR 906, at 912, may determine a first time for receiving a transmission (e.g., the uplink signal at 918) from the UE 904 based on forwarding timing advance information, where the forwarding timing advance information is based on the internal delay of the NCR 906, and where a target of the transmission is the network node 902. In an aspect, 1110 may be performed by the timing control component 198.

In some aspects, the forwarding timing advance procedure may be based on a timing advance value associated with a DL transmission or an UL transmission from the first network entity to the third network entity. For example, referring to FIG. 9, the forwarding timing advance procedure performed by the NCR 906 may be based on a timing advance value associated with a DL transmission (e.g., the downlink signal at 914) from the network node 902 to the UE 904. In another example, referring to FIG. 9, the forwarding timing advance procedure performed by the NCR 906 may be based on a timing advance value associated with a UL transmission (e.g., the uplink signal at 918) from the UE 904 to the network node 902.

In some aspects, the forwarding timing advance information is equal to the timing advance value plus the internal delay. For example, referring to FIG. 9, the forwarding timing advance information on which the first time determination at 912 is based may be equal to the timing advance value plus the internal delay of the NCR 906.

As part of 1108, at 1112, the first network entity may receive the transmission from the second network entity at the first time. For example, referring to FIG. 9, in an aspect in which the forwarding timing advance procedure is performed for a DL transmission, the NCR 906, at 914, may receive a downlink signal from the network node 902 at the first time determined at 912. In an aspect in which the forwarding timing advance procedure is performed for a UL transmission, NCR 906, at 918, may receive an uplink signal from the UE 904 at the first time determined at 912. In an aspect, 1112 may be performed by the timing control component 198.

As part of 1108, at 1114, the first network entity may forward the transmission to the third network entity at a second time. For example, referring to FIG. 9, in an aspect in which the forwarding timing advance procedure is performed for a DL transmission, the NCR 906, at 916, may forward the downlink signal to the UE 904. In an aspect in which the forwarding timing advance procedure is performed for a UL transmission, the NCR 906, at 920, may forward the uplink signal to the network node 902. In an aspect, 1114 may be performed by the timing control component 198.

In some aspects, as part of 1114, at 1116, the first network entity may forward the transmission based on the forwarding configuration. For example, referring to FIG. 9, in an aspect in which a DL forwarding timing advance procedure is performed, the second network entity is the network node 902, and the third network entity is the UE 904, the NCR 906, at 916, may forward the downlink signal based on the forwarding configuration. In an aspect in which a UL forwarding timing advance procedure is performed, the second network entity is the UE 904, and the third network entity is the network node 902, the NCR 906, at 920, may forward the uplink signal based on the forwarding configuration. In an aspect, 1116 may be performed by the timing control component 198.

In some aspects, the forwarding configuration may include an indication of a UL forwarding window or a DL forwarding window associated with the forwarding timing advance procedure, where the UL forwarding window or the DL forwarding window represents a time window configured for receiving the transmission and forwarding the transmission. For example, referring to FIG. 9, the forwarding configuration received at 910 may include an indication of a UL forwarding window or a DL forwarding window associated with the forwarding timing advance procedure, where the UL forwarding window or the DL forwarding window represents a time window configured for receiving the transmission (e.g., receiving the uplink signal at 918 or receiving the downlink signal at 914) and forwarding the transmission (e.g., forwarding the uplink signal at 920 or forwarding the downlink signal at 916).

In some aspects, the indication may include a third value or a first range associated with a start time of the UL forwarding window or the DL forwarding window and a fourth value or a second range associated with an end time of the UL forwarding window or the DL forwarding window, the start time being earlier than the second time. For example, referring to FIG. 9, the indication of the forwarding configuration received at 910 may include a third value or a first range associated with a start time of the UL forwarding window or the DL forwarding window and a fourth value or a second range associated with an end time of the UL forwarding window or the DL forwarding window, the start time being earlier than the second time.

In some aspects, the forwarding advance timing procedure may be based on a timing advance value associated with a DL transmission or an UL transmission from the first network entity to the third network entity, where the start time is earlier than a start time of the DL transmission or the UL transmission based on the timing advance value by the first value (requested at 1104) and the end time is later than an end of the DL transmission or the UL transmission by a second value (requested at 1104). For example, referring to FIG. 9, in an aspect in which a DL forwarding advance timing procedure is performed, the second network entity is the network node 902, and the third network entity is the UE 904, the forwarding advance timing procedure performed by the NCR 906 may be based on a timing advance value associated with the downlink signal (e.g., received at 914) from the network node 902 to the UE 904, where the start time is earlier than a start time of the downlink signal based on the timing advance value by the first value and the end time is later than an end of the downlink signal by the second value. In an aspect in which a UL forwarding advance timing procedure is performed, the second network entity is the UE 904, and the third network entity is the network node 902, the forwarding advance timing procedure performed by the NCR 906 may be based on a timing advance value associated with the uplink signal (e.g., received at 918) from the UE 904 to the network node 902, where the start time is earlier than a start time of the uplink signal based on the timing advance value by the first value and the end time is later than an end of the uplink signal by the second value.

In some aspects, the forwarding configuration may include an indication of an instruction to forward at least one transmission associated with a set of time and frequency resources without a timing advance, where the indication is dynamic, semi-static, periodic, or semi-persistent. For example, referring to FIG. 9, the forwarding configuration received at 910 may include an indication of an instruction to forward at least one transmission associated with a set of time and frequency resources without a timing advance, where the indication is dynamic, semi-static, periodic, or semi-persistent. In some aspects, the timing advance may correspond with one of the timing advance value or the forwarding timing advance information. For example, referring to FIG. 9, the timing advance may correspond with one of the timing advance value or the forwarding timing advance information on which the first time determination at 912 is based.

In some aspects, the forwarding configuration may include an indication of an instruction to forward at least one transmission associated with a PRACH without a timing advance, where the indication is dynamic, semi-static, periodic, or semi-persistent. For example, referring to FIG. 9, the forwarding configuration received at 910 may include an indication of an instruction to forward at least one transmission associated with a PRACH without a timing advance, where the indication is dynamic, semi-static, periodic, or semi-persistent. In some aspects, the timing advance may correspond with one of the timing advance value or the forwarding timing advance information. For example, referring to FIG. 9, the timing advance may correspond with one of the timing advance value or the forwarding timing advance information on which the first time determination at 912 is based.

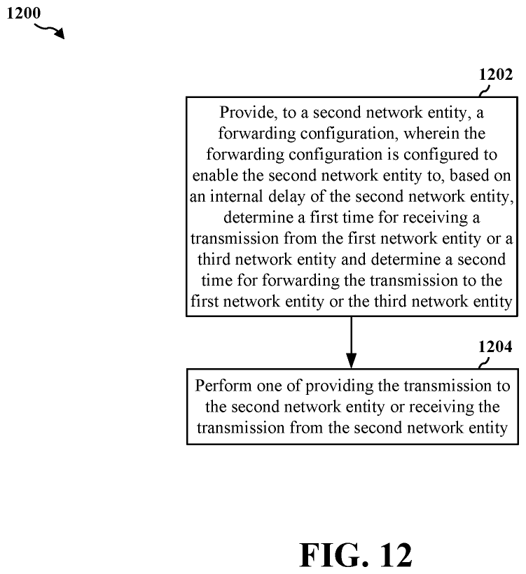

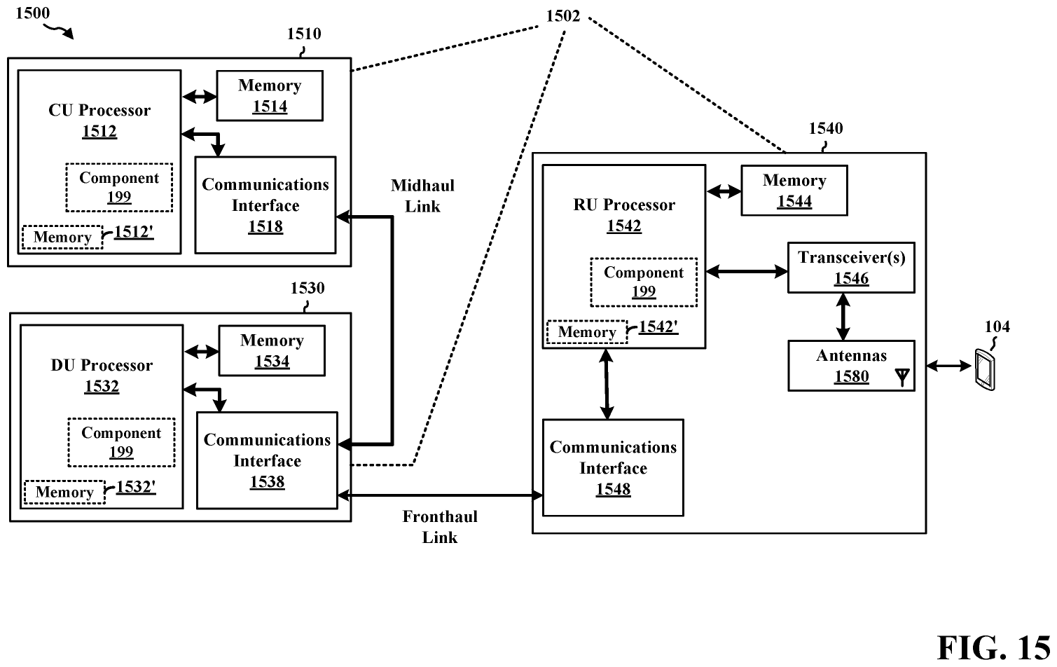

FIG. 12 is a flowchart 1200 illustrating methods of wireless communication at a first network entity in accordance with various aspects of the present disclosure. In some aspects, the first network entity may be the base station 102, the base station 310, the network node 502, the base station 602, the base station 802, or the network node 902, or the network entity 1502 in the hardware implementation of FIG. 15.

In some aspects, the first network entity may correspond to a base station or at least one component of the base station, the second network entity may correspond to a repeater or at least one component of the repeater, and the third network entity may correspond to a UE or one or more components of the UE. For example, referring to FIG. 9, the first network entity may correspond to the network node 902 or at least one component of the network node 902, the second network entity may correspond to the NCR 906 or at least one component of the NCR 906, and the third network entity may correspond to the UE 904 or one or more components of the UE 904.

At 1202, the first network entity may provide, to a second network entity, a forwarding configuration, where the forwarding configuration is configured to enable the second network entity to, based on an internal delay of the second network entity, determine a first time for receiving a transmission from the first network entity or a third network entity and determine a second time for forwarding the transmission to the first network entity or the third network entity. For example, referring to FIG. 9, the network node 902, at 910, may provide the forwarding configuration to the NCR 906. The forwarding configuration may be configured to enable the NCR 906 to, based on an internal delay of the NCR 906, determine a first time for receiving a transmission from the network node 902 (for a downlink transmission) or the UE 904 (for an uplink transmission) and determine a second time for forwarding the transmission to the network node 902 (for an uplink transmission) or the UE 904 (for a downlink transmission). In an aspect, 1202 may be performed by the timing configuration provision component 199.

In some aspects, the internal delay may be a delay of the second network entity accounting for a propagation delay and a processing delay associated with forwarding the transmission. For example, referring to FIG. 9, the internal delay may be delay of the NCR 906 accounting for a propagation delay and a processing delay associated with forwarding the transmission (e.g., at 916 or 920).

At 1204, the first network entity may perform one of providing the transmission to the second network entity or receiving the transmission from the second network entity. For example, referring to FIG. 9, the network node 902, at 914, may provide a downlink signal to the NCR 906, or, at 920, receive an uplink signal from the NCR 906. In an aspect, 1204 may be performed by the timing configuration provision component 199.

In some aspects, the forwarding configuration may include an indication of a UL forwarding window or a DL forwarding window, where the UL forwarding window or the DL forwarding window represents a time window configured for receiving the transmission at the second network entity and forwarding the transmission from the second network entity. For example, referring to FIG. 9, the forwarding configuration provided at 910 may include an indication of a UL forwarding window or a DL forwarding window, where the UL forwarding window or the DL forwarding window represents a time window configured for receiving the transmission at the NCR 906 and forwarding the transmission from the NCR 906.

In some aspects, the indication may include a first value or a first range associated with a start time of the UL forwarding window or the DL forwarding window and a second value or a second range associated with an end time of the UL forwarding window or the DL forwarding window, the start time being earlier than the second time. For example, referring to FIG. 9, the indication included in the forwarding configuration provided at 910 may include a first value or a first range associated with a start time of the UL forwarding window or the DL forwarding window and a second value or a second range associated with an end time of the UL forwarding window or the DL forwarding window, the start time being earlier than the second time.

In some aspects, the forwarding configuration may include an indication of an instruction for the second network entity to forward at least one transmission associated with a set of time and frequency resources without a timing advance, where the indication is dynamic, semi-static, periodic, or semi-persistent. For example, referring to FIG. 9, the forwarding configuration provided at 910 may include an indication of an instruction for the NCR 906 to forward at least one transmission associated with a set of time and frequency resources without a timing advance, where the indication is dynamic, semi-static, periodic, or semi-persistent.

In some aspects, the forwarding configuration may include an indication of an instruction for the second network entity to forward at least one transmission associated with a PRACH without a timing advance, where the indication is dynamic, semi-static, periodic, or semi-persistent. For example, referring to FIG. 9, the forwarding configuration provided at 910 may include an indication of an instruction for the NCR 906 to forward at least one transmission associated with a PRACH without a timing advance, where the indication is dynamic, semi-static, periodic, or semi-persistent.

In some aspects, the first network entity may receive an indication representing value(s), accuracy(ies), or uncertainty range(s) associated with an internal delay of the second network entity via layer 1 (L1), layer 2 (L2), or layer 3 (L3) signaling. For example, referring to FIG. 9, the network node 902, at 908, may receive an indication representing value(s), accuracy(ies), or uncertainty range(s) associated with an internal delay of the NCR 906 via layer 1 (L1), layer 2 (L2), or layer 3 (L3) signaling.

In some aspects, the indication may represent the uncertainty range(s) in an index. For example, referring to FIG. 9, the indication received at 908 may represent the uncertainty range(s) in an index.

In some aspects, the indication may further indicate that the internal delay is based on whether the transmission is a UL transmission or a DL transmission, where a first value of the value(s) of the internal delay is associated with the transmission being the UL transmission and a second value of the value(s) of the internal delay is associated with the transmission being the DL transmission. For example, referring to FIG. 9, the indication received at 908 may further indicate that the internal delay is based on whether the transmission is a UL transmission or a DL transmission, where a first value of the value(s) of the internal delay is associated with the transmission being the UL transmission and a second value of the value(s) of the internal delay is associated with the transmission being the DL transmission.

In some aspects, the indication may further indicate that the value(s) of the internal delay are based on a direction or a set of antennas associated with the transmission. For example, referring to FIG. 9, the indication received at 908 may further indicate that the value(s) of the internal delay are based on a direction or a set of antennas associated with the transmission.

In some aspects, the indication may further indicate that the value(s) of the internal delay are based on a signal power associated with a reception of the transmission. For example, referring to FIG. 9, the indication received at 908 may further indicate that the value(s) of the internal delay are based on a signal power associated with a reception of the transmission at 914 or 918.

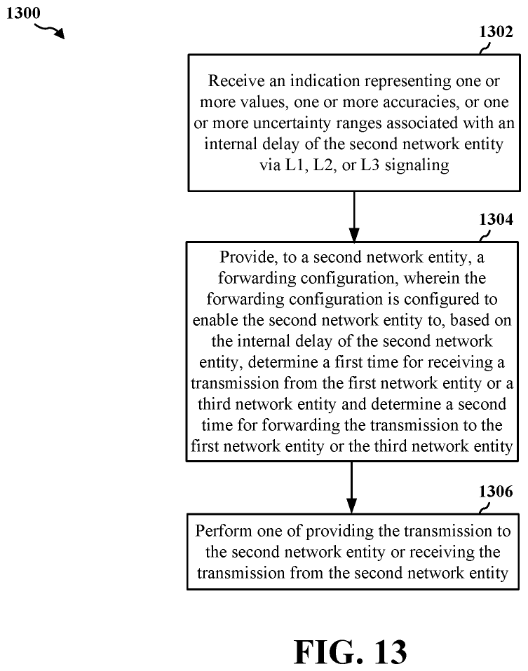

FIG. 13 is a flowchart 1300 illustrating methods of wireless communication at a first network entity in accordance with various aspects of the present disclosure. In some aspects, the first network entity may be the base station 102, the base station 310, the network node 502, the base station 602, the base station 802, or the network node 902, or the network entity 1502 in the hardware implementation of FIG. 15.

In some aspects, the first network entity may correspond to a base station or at least one component of the base station, the second network entity may correspond to a repeater or at least one component of the repeater, and the third network entity may correspond to a UE or one or more components of the UE. For example, referring to FIG. 9, the first network entity may correspond to the network node 902 or at least one component of the network node 902, the second network entity may correspond to the NCR 906 or at least one component of the NCR 906, and the third network entity may correspond to the UE 904 or one or more components of the UE 904.

At 1302, the first network entity may receive an indication representing value(s), accuracy(ies), or uncertainty range(s) associated with an internal delay of the second network entity via layer 1 (L1), layer 2 (L2), or layer 3 (L3) signaling. For example, referring to FIG. 9, the network node 902, at 908, may receive an indication representing value(s), accuracy(ies), or uncertainty range(s) associated with an internal delay of the NCR 906 via layer 1 (L1), layer 2 (L2), or layer 3 (L3) signaling. In an aspect, 1302 may be performed by the timing configuration provision component 199.

In some aspects, the internal delay may be a delay of the second network entity accounting for a propagation delay and a processing delay associated with forwarding the transmission. For example, referring to FIG. 9, the internal delay may be delay of the NCR 906 accounting for a propagation delay and a processing delay associated with forwarding the transmission (e.g., at 916 or 920).

In some aspects, the indication may represent the uncertainty range(s) in an index. For example, referring to FIG. 9, the indication received at 908 may represent the uncertainty range(s) in an index.

In some aspects, the indication may further indicate that the internal delay is based on whether a transmission of the second network entity is a UL transmission or a DL transmission, where a first value of the value(s) of the internal delay is associated with the transmission of the second network entity being the UL transmission and a second value of the value(s) of the internal delay is associated with the transmission being the DL transmission. For example, referring to FIG. 9, the indication received at 908 may further indicate that the internal delay is based on whether a transmission of the NCR 906 is a UL transmission or a DL transmission, where a first value of the value(s) of the internal delay is associated with the transmission being the UL transmission and a second value of the value(s) of the internal delay is associated with the transmission being the DL transmission.

In some aspects, the indication may further indicate that the value(s) of the internal delay are based on a direction or a set of antennas associated with the transmission of the second network entity. For example, referring to FIG. 9, the indication received at 908 may further indicate that the value(s) of the internal delay are based on a direction or a set of antennas associated with the transmission of the NCR 906.

In some aspects, the indication may further indicate that the value(s) of the internal delay are based on a signal power associated with a reception of the transmission of the second network entity. For example, referring to FIG. 9, the indication received at 908 may further indicate that the value(s) of the internal delay are based on a signal power associated with a reception of the transmission of the NCR 906 at 914 or 918.

At 1304, the first network entity may provide, to a second network entity, a forwarding configuration, where the forwarding configuration is configured to enable the second network entity to, based on the internal delay of the second network entity, determine a first time for receiving a transmission from the first network entity or a third network entity and determine a second time for forwarding the transmission to the first network entity or the third network entity. For example, referring to FIG. 9, the network node 902, at 910, may provide the forwarding configuration to the NCR 906. The forwarding configuration may be configured to enable the NCR 906 to, based on the internal delay of the NCR 906, determine a first time for receiving a transmission from the network node 902 (for a downlink transmission) or the UE 904 (for an uplink transmission) and determine a second time for forwarding the transmission to the network node 902 (for an uplink transmission) or the UE 904 (for a downlink transmission). In an aspect, 1304 may be performed by the timing configuration provision component 199.

In some aspects, the forwarding configuration may be based on the indication received at 908.

At 1306, the first network entity may perform one of providing the transmission to the second network entity or receiving the transmission from the second network entity. For example, referring to FIG. 9, the network node 902, at 914, may provide a downlink signal to the NCR 906, or, at 920, receive an uplink signal from the NCR 906. In an aspect, 1306 may be performed by the timing configuration provision component 199.

In some aspects, the forwarding configuration may include an indication of a UL forwarding window or a DL forwarding window, where the UL forwarding window or the DL forwarding window represents a time window configured for receiving the transmission at the second network entity and forwarding the transmission from the second network entity. For example, referring to FIG. 9, the forwarding configuration provided at 910 may include an indication of a UL forwarding window or a DL forwarding window, where the UL forwarding window or the DL forwarding window represents a time window configured for receiving the transmission at the NCR 906 and forwarding the transmission from the NCR 906.

In some aspects, the indication may include a first value or a first range associated with a start time of the UL forwarding window or the DL forwarding window and a second value or a second range associated with an end time of the UL forwarding window or the DL forwarding window, the start time being earlier than the second time. For example, referring to FIG. 9, the indication included in the forwarding configuration provided at 910 may include a first value or a first range associated with a start time of the UL forwarding window or the DL forwarding window and a second value or a second range associated with an end time of the UL forwarding window or the DL forwarding window, the start time being earlier than the second time.

In some aspects, the forwarding configuration may include an indication of an instruction for the second network entity to forward at least one transmission associated with a set of time and frequency resources without a timing advance, where the indication is dynamic, semi-static, periodic, or semi-persistent. For example, referring to FIG. 9, the forwarding configuration provided at 910 may include an indication of an instruction for the NCR 906 to forward at least one transmission associated with a set of time and frequency resources without a timing advance, where the indication is dynamic, semi-static, periodic, or semi-persistent.

In some aspects, the forwarding configuration may include an indication of an instruction for the second network entity to forward at least one transmission associated with a PRACH without a timing advance, where the indication is dynamic, semi-static, periodic, or semi-persistent. For example, referring to FIG. 9, the forwarding configuration provided at 910 may include an indication of an instruction for the NCR 906 to forward at least one transmission associated with a PRACH without a timing advance, where the indication is dynamic, semi-static, periodic, or semi-persistent.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see UE 350 of FIG. 3) and include the additional modules of the apparatus 1404.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, to a second network entity, a forwarding configuration, where the forwarding configuration is configured to enable the second network entity to determine, based on an internal delay of the second network entity, a first time for receiving a transmission from the first network entity or a third network entity and determine a second time for forwarding the transmission to the first network entity or the third network entity, and to perform one of: a provision of the transmission to the second network entity, or a reception of the transmission from the second network entity. The component 199 may be configured to perform any of the aspects described in connection with the flowchart in FIGS. 12 and 13 and/or the aspects performed by the network node 902 in the communication flow in FIG. 9. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 may include means for providing, to a second network entity, a forwarding configuration, where the forwarding configuration is configured to enable the second network entity to determine, based on an internal delay of the second network entity, a first time for receiving a transmission from the first network entity or a third network entity and determine a second time for forwarding the transmission to the first network entity or the third network entity, and means for performing one of providing the transmission to the second network entity, or receiving the transmission from the second network entity. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 16 is a diagram 1600 illustrating an example of a hardware implementation for a network entity 1660. In one example, the network entity 1660 may be within the core network 120. The network entity 1660 may include a network processor 1612. In one example, the network processor 1612 is a cellular baseband processor (or modem), such as the cellular baseband processor 1424 described above. The network processor 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602 or the UE 104. The on-chip memory 1612′ and the additional memory modules 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to perform a forwarding timing advance procedure. To perform the forwarding timing advance procedure, the component 198 may be configured to determine a first time for receiving a transmission from a second network entity based on forwarding timing advance information, where the forwarding timing advance information is based on an internal delay of the first network entity, and where a target of the transmission is a third network entity, to receive the transmission from the second network entity at the first time, and to forward the transmission to the third network entity at a second time. The component 198 may be configured to perform any of the aspects described in connection with the flowchart in FIGS. 10 and 11 and/or the aspects performed by the NCR 906 in the communication flow in FIG. 9. The component 198 may be within the processor 1612. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. In one configuration, the network entity 1660 may include means for performing a forwarding timing advance procedure. To perform the forwarding timing advance procedure, the network entity 1660 may include means for to determining a first time for receiving a transmission from a second network entity based on forwarding timing advance information, where the forwarding timing advance information is based on an internal delay of the first network entity, and where a target of the transmission is a third network entity, means for receiving the transmission from the second network entity at the first time, and means for forwarding the transmission to the third network entity at a second time The means may be the component 198 of the network entity 1660 configured to perform the functions recited by the means.

Various aspects relate generally to communication systems. Some aspects more specifically relate to timing control of a repeater. In some examples, a repeater (e.g., a network-controlled repeater (NCR)) may perform a forwarding timing advance procedure. In accordance with the procedure, the repeater determines a first time for receiving a transmission from a network entity (e.g., a network node or a UE) based on forwarding timing advance information. The forwarding timing advance information may be based on an internal delay of the repeater. The first time may be determined before the transmission is received by the repeater. The repeater may forward the transmission to another network entity at a second time. For example, for uplink transmissions, the repeater may receive an uplink transmission from a UE at the determined first time and forward the uplink transmission to the network node at the second time. For downlink transmissions, the repeater may receive a downlink transmission from the network node at the determined first time and forward the downlink transmission to the UE at the second time.

Particular aspects of the subject matter described in this disclosure can be implemented to realize one or more of the following potential advantages. In some examples, by considering the internal delay of the repeater when receiving and/or forwarding a transmission, the transmission and reception boundaries of the repeater may be aligned. If such boundaries are not properly aligned, the repeater may attempt to forward a signal prematurely, thereby causing a portion of the signal to be lost. In another example, the repeater may continue to forward after transmission of the signal is complete. This may cause the repeater to transmit noise and interference, which may result in intersymbol interference at the target of the transmission (e.g., a network node or a UE). Accordingly, properly aligning the transmission and reception boundaries of the repeater enables the repeater to accurately determine when to start forwarding a signal and when to stop forwarding a signal, which prevents signal loss and interference.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method at a first network entity for wireless communication, including: perform a forwarding timing advance procedure, where performing the forwarding timing advance procedure includes determining a first time for receiving a transmission from a second network entity based on forwarding timing advance information, where the forwarding timing advance information is based on an internal delay of the first network entity, and where a target of the transmission is a third network entity, receiving the transmission from the second network entity at the first time, and forwarding the transmission to the third network entity at a second time.

Aspect 2 is the method of aspect 1, where the forwarding timing advance procedure is based on a timing advance value associated with a DL transmission or a UL transmission from the first network entity to the third network entity.

Aspect 3 is the method of aspect 2, where the forwarding timing advance information is equal to the timing advance value plus the internal delay.

Aspect 4 is the method of any of aspects 1 to 3, further including: receiving a forwarding configuration from the second network entity or the third network entity via L1, L2, or L3 signaling, and forwarding the transmission includes: forwarding the transmission based on the forwarding configuration.

Aspect 5 is the method of aspect 4, where the forwarding configuration includes an indication of a UL forwarding window or a DL forwarding window associated with the forwarding timing advance procedure, and where the UL forwarding window or the DL forwarding window represents a time window configured for receiving the transmission and forwarding the transmission.

Aspect 6 is the method of aspect 5, where the indication includes a first value or a first range associated with a start time of the UL forwarding window or the DL forwarding window and a second value or a second range associated with an end time of the UL forwarding window or the DL forwarding window, the start time being earlier than the second time.

Aspect 7 is the method of aspect 6, where the forwarding advance timing procedure is based on a timing advance value associated with a DL transmission or an UL transmission from the first network entity to the third network entity, and where the start time is earlier than a start time of the DL transmission or the UL transmission based on the timing advance value by a third value and the end time is later than an end of the DL transmission or the UL transmission by a fourth value.

Aspect 8 is the method of aspect 7, where the third value or the fourth value is associated with a channel type for the transmission, a beam associated with receiving or forwarding the transmission, or a set of time or frequency resources associated with the transmission.

Aspect 9 is the method of aspect 8, where the channel type is one of: a PUSCH, a PUCCH, a PDSCH, a PDCCH, a PRACH, an SRS, an SSB, a CSI-RS, or a PRS.

Aspect 10 is the method of aspects 7 to 9, further including: transmitting a request for the third value or the fourth value to the second network entity or the third network entity via the L1, L2, or L3 signaling.

Aspect 11 is the method of any of aspects 4 to 10, where the forwarding configuration includes an indication of an instruction to forward at least one transmission associated with a set of time and frequency resources without a timing advance, where the indication is dynamic, semi-static, periodic, or semi-persistent.

Aspect 12 is the method of aspect 11, where the timing advance corresponds with one of the timing advance value or the forwarding timing advance information.

Aspect 13 is the method of any of aspects 4 to 12, where the forwarding configuration includes an indication of an instruction to forward at least one transmission associated with a PRACH without a timing advance, where the indication is dynamic, semi-static, periodic, or semi-persistent.

Aspect 14 is the method of aspect 13, where the timing advance corresponds with one of the timing advance value or the forwarding timing advance information.

Aspect 15 is the method of any of aspects 1 to 14, further including: transmitting an indication representing value(s), accuracy(ies), or uncertainty range(s) associated with the internal delay to the second network entity or the third network entity via L1 L2, or L3 signaling.

Aspect 16 is the method of aspect 15, where the indication representing the uncertainty range(s) is an index.

Aspect 17 is the method of any of aspects 15 and 16, where the indication further indicates the internal delay is based on whether the transmission is a UL transmission or a DL transmission, and where a first value of the one or more values of the internal delay is associated with the transmission being the UL transmission and a second value of the one or more values of the internal delay is associated with the transmission being the DL transmission.

Aspect 18 is the method of any of aspects 15 to 17, where the indication further indicates that the one or more values of the internal delay are based on a direction or a set of antennas associated with the transmission.

Aspect 19 is the method of any of aspects 15 to 18, where the indication further indicates that the one or more values of the internal delay are based on a signal power associated with a reception of the transmission.

Aspect 20 is the method of any of aspects 1 to 19, where the first network entity corresponds to a repeater or at least one component of the repeater, where the second network entity corresponds to a UE or at least one component of the UE, where the third network entity corresponds to a base station or one or more components of the base station, and where the forwarding timing advance procedure is a UL forwarding timing advance procedure.

Aspect 21 is the method of any of aspects 1 to 19, where the first network entity corresponds to a repeater or at least one component of the repeater, where the third network entity corresponds to a UE or at least one component of the UE, where the second network entity corresponds to a base station or one or more components of the base station, and where the forwarding timing advance procedure is a DL forwarding timing advance procedure.

Aspect 22 is the method of any of aspects 1 to 21, where the internal delay is a delay of the first network entity accounting for a propagation delay and a processing delay associated with forwarding the transmission.

Aspect 23 is a method at a first network entity for wireless communication, including: providing, to a second network entity, a forwarding configuration, where the forwarding configuration is configured to enable the second network entity to determine, based on an internal delay of the second network entity, a first time for receiving a transmission from the first network entity or a third network entity and determine a second time for forwarding the transmission to the first network entity or the third network entity; and performing one of providing the transmission to the second network entity or receiving the transmission from the second network entity.

Aspect 24 is the method of aspect 23, where the forwarding configuration includes an indication of a UL forwarding window or a DL forwarding window, and where the UL forwarding window or the DL forwarding window represents a time window configured for receiving the transmission at the second network entity and forwarding the transmission from the second network entity.

Aspect 25 is the method of aspect 24, where the indication includes a first value or a first range associated with a start time of the UL forwarding window or the DL forwarding window and a second value or a second range associated with an end time of the UL forwarding window or the DL forwarding window, the start time being earlier than the second time.

Aspect 26 is the method of any of aspects 23 to 25, where the forwarding configuration includes an indication of an instruction for the second network entity to forward at least one transmission associated with a set of time and frequency resources without a timing advance, where the indication is dynamic, semi-static, periodic, or semi-persistent.

Aspect 27 is the method of aspect 26, where the timing advance corresponds with one of the timing advance value or the forwarding timing advance information.

Aspect 28 is the method of any of aspects 23 to 25, where the forwarding configuration includes an indication of an instruction to forward at least one transmission associated with a PRACH without a timing advance, where the indication is dynamic, semi-static, periodic, or semi-persistent.

Aspect 29 is the method of aspect 28, where the timing advance corresponds with one of the timing advance value or the forwarding timing advance information.

Aspect 30 is the method of any of aspects 23-29, further including: receiving an indication representing one or more values, one or more accuracies, or one or more uncertainty ranges associated with an internal delay of the second network entity via L1, L2, or L3 signaling.

Aspect 31 is the method of aspect 30, where the indication representing the one or more uncertainty ranges is an index.

Aspect 32 is the method of any of aspects 30 and 31, where the indication further indicates the internal delay is based on whether the transmission is a UL transmission or a DL transmission, and where a first value of the value(s) of the internal delay is associated with the transmission being the UL transmission and a second value of the value(s) of the internal delay is associated with the transmission being the DL transmission.

Aspect 33 is the method of any of aspects 30 to 32, where the indication further indicates that the value(s) of the internal delay are based on a direction or a set of antennas associated with the transmission.

Aspect 34 is the method of any of aspects 30 to 33, where the indication further indicates that the value(s) of the internal delay are based on a signal power associated with receiving the transmission.

Aspect 35 is the method of any of aspects 23 to 34, where the first network entity corresponds to a base station or at least one component of the base station, where the second network entity corresponds to a repeater or at least one component of the repeater, and where the third network entity corresponds to UE or at least one component of the UE.

Aspect 36 is the method of any of aspects 23 to 35, where the internal delay is a delay of the second network entity accounting for a propagation delay and a processing delay associated with forwarding the transmission.

Aspect 37 is an apparatus for wireless communication at a first network entity. The apparatus includes a memory; and at least one processor coupled to the memory, the at least one processor is configured to implement any of aspects 1 to 22.

Aspect 38 is the apparatus of aspect 37, further including at least one of a transceiver or an antenna coupled to the at least one processor.

Aspect 39 is an apparatus for wireless communication at a first network entity. The apparatus includes a memory; and at least one processor coupled to the memory, the at least one processor is configured to implement any of aspects 23 to 36.

Aspect 40 is the apparatus of aspect 39, further including at least one of a transceiver or an antenna coupled to the at least one processor.

Aspect 41 is an apparatus for wireless communication including means for implementing any of aspects 1 to 22.

Aspect 42 is an apparatus for wireless communication including means for implementing any of aspects 23 to 36.

Aspect 43 is a computer-readable medium (e.g., a non-transitory computer-readable medium) storing computer executable code, where the code when executed by a processor causes the processor to implement any of aspects 1 to 22.

Aspect 44 is a computer-readable medium (e.g., a non-transitory computer-readable medium) storing computer executable code, where the code when executed by a processor causes the processor to implement any of aspects 23 to 36.

What is claimed is:

1. A first network entity for wireless communication, comprising:
a memory; and
at least one processor coupled to the memory, wherein the at least one processor is configured to:
perform a forwarding timing advance procedure, wherein to perform the forwarding timing advance procedure, the at least one processor is configured to:
determine a first time for receiving a transmission from a second network entity based on forwarding timing advance information, wherein the forwarding timing advance information is based on an internal delay of the first network entity, and wherein a target of the transmission is a third network entity;
receive the transmission from the second network entity at the first time; and
forward the transmission to the third network entity at a second time.

2. The first network entity of claim 1, wherein the forwarding timing advance procedure is based on a timing advance value associated with a downlink (DL) transmission or an uplink (UL) transmission from the first network entity to the third network entity.

3. The first network entity of claim 2, wherein the forwarding timing advance information is equal to the timing advance value plus the internal delay.

4. The first network entity of claim 1, wherein the at least one processor is configured to:
receive a forwarding configuration from the second network entity or the third network entity via layer 1 (L1), layer 2 (L2), or layer 3 (L3) signaling, wherein to forward the transmission, the at least one processor is configured to forward the transmission based on the forwarding configuration.

5. The first network entity of claim 4, wherein the forwarding configuration comprises an indication of an uplink (UL) forwarding window or a downlink (DL) forwarding window associated with the forwarding timing advance procedure, and wherein the UL forwarding window or the DL forwarding window represents a time window configured for receiving the transmission and forwarding the transmission.

6. The first network entity of claim 5, wherein the indication comprises a first value or a first range associated with a start time of the UL forwarding window or the DL forwarding window and a second value or a second range associated with an end time of the UL forwarding window or the DL forwarding window, the start time being earlier than the second time.

7. The first network entity of claim 6, wherein the forwarding advance timing procedure is based on a timing advance value associated with a DL transmission or an UL transmission from the first network entity to the third network entity, and wherein the start time is earlier than a start time of the DL transmission or the UL transmission based on the timing advance value by a third value and the end time is later than an end of the DL transmission or the UL transmission by a fourth value.

8. The first network entity of claim 7, wherein the third value or the fourth value is associated with a channel type for the transmission, a beam associated with receiving or forwarding the transmission, or a set of time or frequency resources associated with the transmission.

9. The first network entity of claim 8, wherein the channel type is one of:
a physical uplink shared channel (PUSCH);
a physical uplink control channel (PUCCH);
a physical downlink shared channel (PDSCH);
a physical downlink control channel (PDCCH);
a physical random access channel (PRACH);
a sounding reference signal (SRS);
a synchronization signal block (SSB);
a channel status information (CSI) reference signal (CSI-RS); or
or a positioning reference signal (PRS).

10. The first network entity of claim 7, wherein the at least one processor is configured to:
transmit a request for the third value or the fourth value to the second network entity or the third network entity via the L1, L2, or L3 signaling.

11. The first network entity of claim 7, wherein the forwarding configuration comprises an indication of an instruction to forward at least one transmission associated with a set of time and frequency resources without a timing advance, wherein the indication is dynamic, semi-static, periodic, or semi-persistent.

12. The first network entity of claim 11, wherein the timing advance corresponds with one of the timing advance value or the forwarding timing advance information.

13. The first network entity of claim 7, wherein the forwarding configuration comprises an indication of an instruction to forward at least one transmission associated with a physical random access channel (PRACH) without a timing advance, wherein the indication is dynamic, semi-static, periodic, or semi-persistent.

14. The first network entity of claim 13, wherein the timing advance corresponds with one of the timing advance value or the forwarding timing advance information.

15. The first network entity of claim 1, wherein the at least one processor is configured to:
transmit an indication representing one or more values, one or more accuracies, or one or more uncertainty ranges associated with the internal delay to the second network entity or the third network entity via layer 1 (L1), layer 2 (L2), or layer 3 (L3) signaling.

16. The first network entity of claim 15, wherein the indication representing the one or more uncertainty ranges is an index.

17. The first network entity of claim 15, wherein the indication further indicates the internal delay is based on whether the transmission is an uplink (UL) transmission or a downlink (DL) transmission, and wherein a first value of the one or more values of the internal delay is associated with the transmission being the UL transmission and a second value of the one or more values of the internal delay is associated with the transmission being the DL transmission.

18. The first network entity of claim 15, wherein the indication further indicates that the one or more values of the internal delay are based on a direction or a set of antennas associated with the transmission.

19. The first network entity of claim 15, wherein the indication further indicates that the one or more values of the internal delay are based on a signal power associated with a reception of the transmission.

20. The first network entity of claim 1, wherein the first network entity corresponds to a repeater or at least one component of the repeater, wherein the second network entity corresponds to a user equipment (UE) or at least one component of the UE, wherein the third network entity corresponds to a base station or one or more components of the base station, and wherein the forwarding timing advance procedure is an uplink (UL) forwarding timing advance procedure.

21. The first network entity of claim 1, wherein the first network entity corresponds to a repeater or at least one component of the repeater, wherein the third network entity corresponds to a user equipment (UE) or at least one component of the UE, wherein the second network entity corresponds to a base station or one or more components of the base station, and wherein the forwarding timing advance procedure is a downlink (DL) forwarding timing advance procedure.

22. The first network entity of claim 1, wherein the internal delay is a delay of the first network entity accounting for a propagation delay and a processing delay associated with forwarding the transmission.

23. A first network entity for wireless communication, comprising:
a memory; and
at least one processor coupled to the memory, wherein the at least one processor is configured to:
provide, to a second network entity, a forwarding configuration, wherein the forwarding configuration is configured to enable the second network entity to determine, based on an internal delay of the second network entity, a first time for receiving a transmission from the first network entity or a third network entity and determine a second time for forwarding the transmission to the first network entity or the third network entity; and
perform one of:
a provision of the transmission to the second network entity; or
a reception of the transmission from the second network entity.

24. The first network entity of claim 23, wherein the forwarding configuration comprises an indication of an uplink (UL) forwarding window or a downlink (DL) forwarding window, and wherein the UL forwarding window or the DL forwarding window represents a time window configured for receiving the transmission at the second network entity and forwarding the transmission from the second network entity.

25. The first network entity of claim 24, wherein the indication comprises a first value or a first range associated with a start time of the UL forwarding window or the DL forwarding window and a second value or a second range associated with an end time of the UL forwarding window or the DL forwarding window, the start time being earlier than the second time.

26. The first network entity of claim 23, wherein the forwarding configuration comprises an indication of an instruction for the second network entity to forward at least one transmission associated with a set of time and frequency resources without a timing advance, wherein the indication is dynamic, semi-static, periodic, or semi-persistent.

27. The first network entity of claim 23, wherein the forwarding configuration comprises an indication of an instruction to forward at least one transmission associated with a physical random access channel (PRACH) without a timing advance, wherein the indication is dynamic, semi-static, periodic, or semi-persistent.

28. The first network entity of claim 23, further comprising:
receive an indication representing one or more values, one or more accuracies, or one or more uncertainty ranges associated with the internal delay of the second network entity via layer 1 (L1), layer 2 (L2), or layer 3 (L3) signaling.

29. A method of wireless communication performed by a first network entity, comprising:
performing a forwarding timing advance procedure comprising:
determining a first time for receiving a transmission from a second network entity based on forwarding timing advance information, wherein the forwarding timing advance information is based on an internal delay of the first network entity, wherein a target of the transmission is a third network entity;
receiving the transmission from the second network entity at the first time; and
forwarding the transmission to the third network entity at a second time.

30. A method of wireless communication performed by a first network entity, comprising:
providing, to a second network entity, a forwarding configuration, wherein the forwarding configuration is configured to enable the second network entity, based on an internal delay of the second network entity, to determine a first time for receiving a transmission from the first network entity or a third network entity and determine a second time for forwarding the transmission to the first network entity or the third network entity; and
performing one of:
providing the transmission to the second network entity; or
receiving the transmission from the second network entity.
